(19) United States
(12) Patent Application Publication
(10) Pub. No.: US 2026/0136965 A1
(43) Pub. Date: May 14, 2026

(54) TEMPLATE CELL ALIGNMENT FOR INTERPOSER LAYOUT DESIGN

(71) Applicant: Microsoft Technology Licensing, LLC, Redmond, WA (US)

(72) Inventors: Olga M. CALDERON, San Jose, CA (US); Chunchieh HUANG, Fremont, CA (US); Charles Kenneth ROBINSON, Apex, NC (US); Gurupada MANDAL, San Jose, CA (US)

(73) Assignee: Microsoft Technology Licensing, LLC, Redmond, WA (US)

(21) Appl. No.: 18/943,274

(22) Filed: Nov. 11, 2024

(51) Int. Cl. H01L 23/498; G06F 30/392; H01L 23/00

(52) U.S. Cl. CPC H10W 70/65; G06F 30/392; H10W 70/635; H10W 72/9445; H10W 90/724

(57) ABSTRACT

Systems and methods are provided for implementing template cell alignment for interposer layout design. In examples, object template cells are used within a layout design UI (e.g., for the interposer). In some examples, the template cells include vertically aligned pattern templates of cells corresponding to a set of microbump contact pads of an SoC device, a set of microbump contact pads of an interposer, interconnections within the interposer, a chip connect contact pad of the interposer, and a chip connect contact pad of a semiconductor package. In examples, the vertically aligned pattern templates of cells are grouped to form a template cell of its own that can be duplicated for design of an IC device or for designs of multiple different IC devices across one or more IC design projects.

### BACKGROUND

Integrated circuit (“IC”) devices are ubiquitous in the modern world of electronics. However, as designs for IC devices become more complex, planning for placement of components (such as microbump contact pads, chip connection contact pads, and interconnections) becomes more critical. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for template cell alignment for interposer layout design. In an example, a computing system receives a first design file for a system on a chip (“SoC”) device from a first device, the first design file including first data indicating initial first locations for placement of a plurality of first sets of microbump contact pads on an underside of a die corresponding to the SoC device. The computing system updates, in a second design file for an interposer device, initial second locations for placement of a plurality of second sets of microbump contact pads on a topside of the interposer device to updated second locations that align with one of the initial first locations or updated first locations when the SoC device is mounted on the interposer device, each of the second sets of microbump contact pads being arranged in a first pattern. The computing system generates information regarding a second pattern for each first set of microbump contact pads that mirrors the first pattern. The computing system updates, in the second design file, initial third locations for placement of a plurality of first chip connection contact pads on an underside of the interposer device to updated third locations, and corresponding locations for a plurality of first sets of interconnections through one or more layers of the interposer device between each second set of microbump contact pads and one of the plurality of first chip connection contact pads, wherein a center of each of the first pattern of each second set of microbump contact pads and a center of a corresponding one of the plurality of first chip connection contact pads are aligned vertically. The computing system sends a design update file to the first device, the design update file including second data, the second data including the updated second locations of the plurality of second sets of microbump contact pads and the information regarding the second pattern for each first set of microbump contact pads that mirrors the first pattern.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing template cell alignment for interposer layout design.

FIG. 2A depicts a sectional elevation view of an example model of an IC device that is manufactured and assembled after implementing template cell alignment for interposer layout design.

FIGS. 2B-2E depict example partial sectional top or bottom views of components of the IC device of FIG. 2A for implementing an example template cell alignment for interposer layout design process.

FIGS. 2F-2I depict alternative example partial sectional top or bottom views of components of the IC device of FIG. 2A for implementing example template cell alignments for interposer layout design process.

FIGS. 3A-3D depict example template cells for different interposer layers that are aligned vertically within an interposer device when implementing template cell alignment for interposer layout design.

FIGS. 4A-4E depict an example method for implementing template cell alignment for interposer layout design.

FIGS. 5A-5E depict another example method for implementing template cell alignment for interposer layout design.

FIG. 6 depicts yet another example method for implementing template cell alignment for interposer layout design.

FIG. 7 depicts still another example method for implementing template cell alignment for interposer layout design.

FIG. 8 depicts another example method for implementing template cell alignment for interposer layout design.

FIG. 9 depicts a block diagram illustrating example physical components of a computing device with which aspects of the technology may be practiced.

### DETAILED DESCRIPTION OF CERTAIN EMBODIMENTS

As briefly discussed above, as designs for IC devices become more complex, planning for placement of components (such as microbump contact pads, chip connection contact pads, and interconnections) becomes more critical. Existing IC device designs require different teams of designers working on different parts of the IC device: (1) an SoC device design team; (2) an interposer design team; (3) a semiconductor package design team; and (4) a place and route team. Each team has its own objectives and concerns, and teams typically work around designs by the other teams, leading to complicated interconnections and differing connection patterns. For example, even if two or more sets of microbump contact pads on the SoC device design are the same on different portions of the SoC device, the overall connections through the interposer and to the semiconductor package for the two or more sets may differ due to the interconnections and the chip connections being at different relative lateral distances from the microbump contact pad locations.

The present technology provides for template cell alignment for interposer layout design. The present technology utilizes object templates and pattern templates (collectively referred to herein as “template cells” or “cells”) within a layout design user interface (“UI”). In some examples, the template cells include vertically aligned pattern templates of cells corresponding to a set of microbump contact pads of an SoC device, a set of microbump contact pads of an interposer, interconnections within the interposer, a chip connect contact pad of the interposer, and a chip connect contact pad of a semiconductor package. In examples, the vertically aligned pattern templates of cells are grouped to itself form a template cell that can be duplicated for design of an IC device or for designs of multiple different IC devices across one or more IC design projects. In this manner, routing complexity is minimized, as is scenic routing (e.g., complicated, meandering routing) within layers of the interposer.

In some aspects, the present technology provides for a repeatable (and identical) correct-by-construction layout of matching custom microbump contact pad macros for both the interposer and a top die. In some cases, the top die can be an SoC chip or other chiplets that are placed on the interposer. The custom microbump contact pad macros on the interposer each has a custom macro (e.g., a matching, corresponding, or sibling macro) placed on the top die. The macros contain the required layout of metal routing layers and vias to properly connect from an underside bump (e.g., a controlled collapse chip connection (“C4”) bump) through the interposer up to the topside microbumps. Microbumps on the top die connect to the microbumps on the interposer. The matching sibling macros on the top die contain the required layout of metal routing layers and vias to properly connect form the microbumps down to other layers in the top die. The custom bumps include different configurations, such as a C4 bump surrounded by and connected to any number of microbumps (e.g., 8, 6, 5, 4, 3, 2, etc.). Whether sued in custom routing or “Place and Route” flows, using these completed custom microbump contact pad macros allows user or the tools to place, in a design file for the interposer, 1000 of such completed N-microbump macros (e.g., 8-microbump, 6-microbump, 5-microbump, 4-microbump, 3-microbump, or 2-microbump macros) instead of separately placing a corresponding 1000 C4 bumps, 1000×N microbumps, 60×N via arrays, and greater than 7×N metal routes, etc., to correctly connect the C4 bumps to the microbumps. For instance, for an 8-microbump pattern, 1000 completed 8-microbump macros are placed instead of having to separately place a corresponding 1000 C4 bumps, 8000 microbumps, 480000 via arrays, and greater than 56000 metal routes, etc., to correctly connect the C4 bumps to the microbumps. When these 1000 completed 8-microbump macros are placed, in the design file of the interposer, at the corresponding locations of the sibling macro placements on the top die, the 8000 microbump placements are guaranteed to be correct. In some cases, rather than the 1000 completed N-microbump macros, 20000 or more completed N-microbump macros may be placed.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

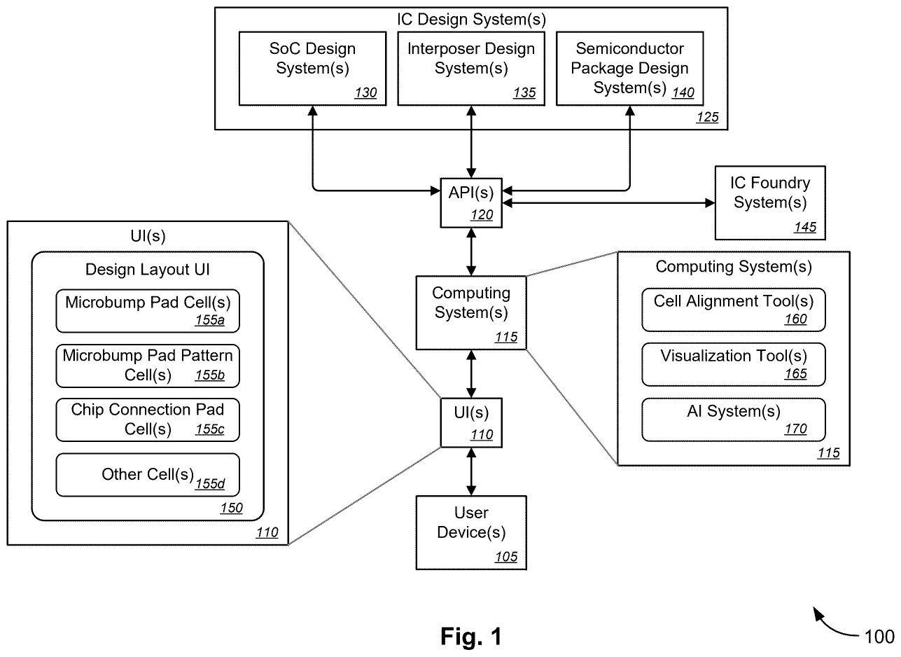

Turning to the embodiments as illustrated by the drawings, FIGS. 1-9 illustrate some of the features of methods, systems, and apparatuses for implementing template cell alignment for interposer layout design, as referred to above. The methods, systems, and apparatuses illustrated by FIGS. 1-9 refer to examples of different embodiments that include various components and steps, which can be considered alternatives or which can be used in conjunction with one another in the various embodiments. The description of the illustrated methods, systems, and apparatuses shown in FIGS. 1-9 is provided for purposes of illustration and should not be considered to limit the scope of the different embodiments.

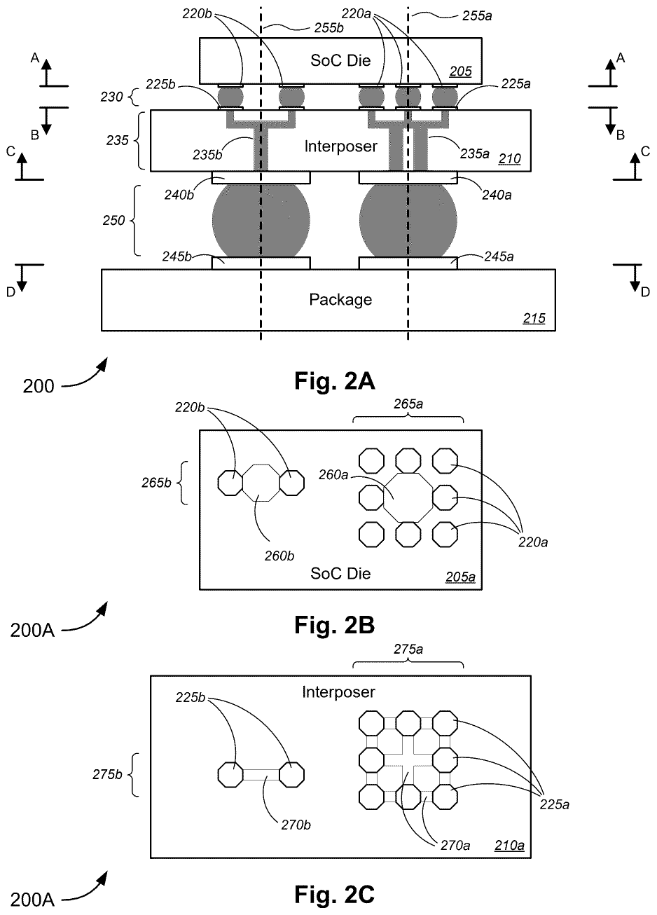

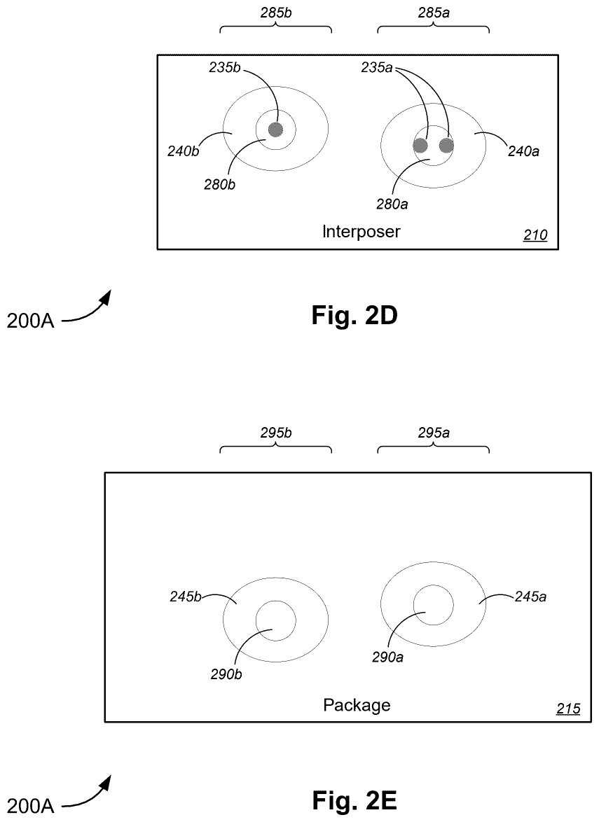

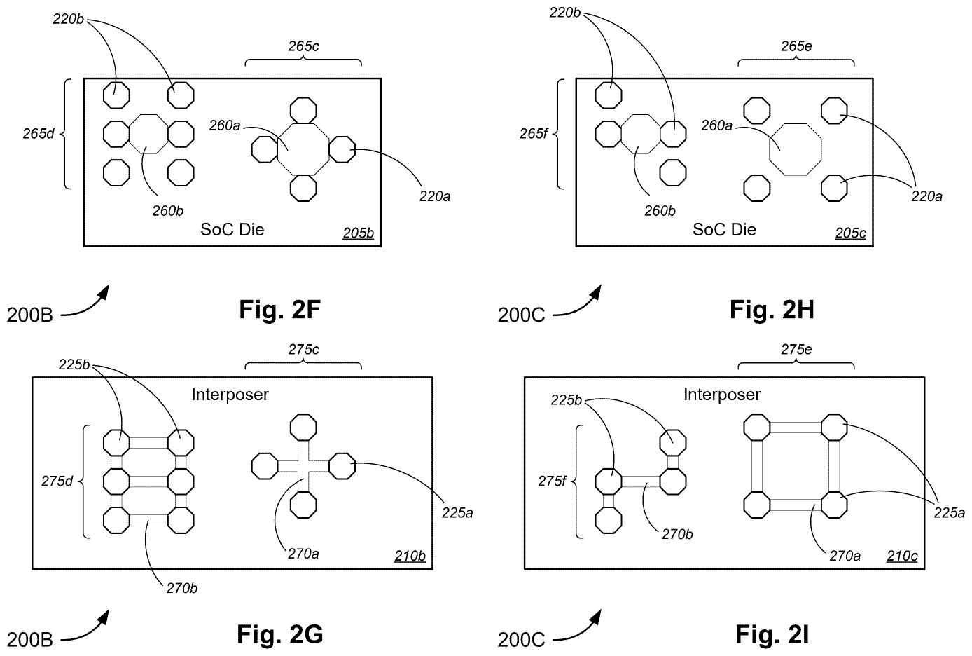

FIG. 1 depicts an example system 100 for implementing template cell alignment for interposer layout design, as part of IC device design. IC device design includes designing layers, contact points, and connections for an SoC device, an interposer, and a semiconductor package. As shown in FIG. 2A, the SoC device, the interposer, and the semiconductor package are stacked vertically, one atop another, with the interposer disposed between the SoC device and the semiconductor package. The interposer has multiple layers with lateral interconnections (e.g., layer traces) and vertical interconnections (e.g., through-silicon vias (“TSVs”)) electrically connecting contact pads on an SoC-side (e.g., microbump contact pads) of the interposer with contact pads on a semiconductor package-side (e.g., chip connect contact pads) of the interposer.

With reference to FIG. 1, example system 100 includes a user device(s) 105, a UI(s) 110, a computing system(s) 115, an application programming interface(s) (“API(s)”) 120, an IC design system(s) 125, and an IC foundry system(s) 145. In examples, the IC design system(s) 125 includes a SoC design system(s) 130, an interposer design system(s) 135, and/or a semiconductor package design system(s) 140. In some instances, the API(s) 120 communicatively couples the computing system(s) 115 to each of one or more of the IC design system(s) 125 includes the SoC design system(s) 130, the interposer design system(s) 135, the semiconductor package design system(s) 140, and/or the IC foundry system(s) 145. In this manner, design files for the SoC, the interposer, and/or the semiconductor package can be passed between the computing system(s) 115 and each of the one or more of these systems 125-145. Although an API(s) 120 is shown connecting these components, other communication routes (including file transfer protocols, packet transfer protocols, email exchanges, file sharing systems, and/or other data transfer techniques and/or systems) can be used.

In examples, the UI(s) 110 includes a design layout UI 150 that enables generating, duplicating, interacting with, modifying or manipulating, and/or arranging template cells 155, which are design constructs that each forms a geometric pattern or a combination of geometric patterns that can be used as building blocks for forming more intricate patterns for components (including contact pads, routes, traces, vias or TSVs, probe pads, and/or other connections). In some examples, the template cells 155 include a microbump contact pad cell(s) 155a, a microbump contact pad pattern cell(s) 155b, a chip connection (e.g., controlled collapse chip connection (“C4”)) contact pad cell(s) 155c, and/or the like other cell(s) 155d. In examples, the computing system(s) 115 includes at least one of a cell alignment tool(s) 160 and a visualization tool(s) 165. In some examples, the computing system(s) 115 further includes an artificial intelligence (“AI”) system(s) 170 or an interface to an external AI system(s). In an example, the cell alignment tool(s) 160 provides guidance to a user of the user device(s) 105 as well as tools and options for aligning template cells 155 designed or generated for an SoC device (e.g., microbump contact pad cell(s) 155a or microbump contact pad pattern cell(s) 155b), interposer template cells 155 (e.g., corresponding microbump contact pad cell(s) 155a or microbump contact pad pattern cell(s) 155b, as well as chip connection contact pad cell(s) 155c and/or other cell(s) 155d), and semiconductor package template cells 155 (e.g., chip connection contact pad cell(s) 155c and/or other cell(s) 155d), such that these cells stack one over the other to correspond to vertical alignment of the microbump and chip connection contact pads when the SoC device, the interposer, and the semiconductor package are joined to assemble an IC package or IC device. Visualization tool(s) 165 generates views that are manipulable to show different perspectives and angles, as well as color coded components for different layers, and in some cases, exploded views, two-dimensional (“2D”) views and/or three-dimensional (“3D”) views. Alternatively or additionally, the cell alignment tool(s) 160 in conjunction with the AI system(s) 170 autonomously analyzes the template cells for the SoC device, the interposer, and the semiconductor package, and autonomously modifies and rearranges the template cells to produce the vertical alignment of components (e.g., microbump and chip connection contact pads, as well as other components such as probe pads) of the SoC device, the interposer, and the semiconductor package. In some cases, the cell alignment tool(s) 160 modifies and rearranges the template cells to produce the vertical alignment of components of the SoC device, the interposer, and the semiconductor package, in response to user input.

In some examples, the AI system(s) 170 (or the external AI system(s)) includes generative AI and/or ML models such as small language models (“SLMs”), large language models (“LLMs”), or other language models. Alternatively or additionally, the AI system(s) 170 includes other ML models that are non-LLM models or non-language models, the other ML models including convolutional neural networks (“CNNs”), recurrent neural networks (“RNNs”), deep neural networks (“DNNs”), transformers, and/or long short-term memory networks (“LSTMs”). As used herein, an LLM refers to a machine learning model that is trained and fine-tuned on a large corpus of media (e.g., text, audio, video, or software code), and that can be accessed and used through an API or a platform. An SLM is similar to an LLM, except that it has fewer parameters and requires less data and time to be trained. An SLM and an LLM each performs a variety of tasks, including generating and classifying media, answering user requests and questions in a conversational manner, and translating text from one language to another. Examples of LLMs (or more generally language models (“LMs”)) include Bidirectional Encoder Representations from Transformers (“BERT”), Word2Vec, Global and Vectors (“GloVe”), Embeddings from Language Models (“ELMo”), XLNet, Generative Pre-trained Transformer (“GPT”)-3 or GPT-4, Large Language Model Meta AI (“LLaMA”) 2, or BigScience Large Open-science Open-access Multilingual Language Model (BLOOM). In examples, the other ML models include multimodal models that are capable of either one or more of text, image, audio, or video as both input and output, or using one or a first combination of text, image, audio, and/or video as input and using another or a second combination of text, image, audio, and/or video as output. Examples of multimodal models include GPT-4 (which can use both text and image as inputs), LLaMA 2 (which allows for image and video inputs), or Gemini (which was designed to process text, images, audio, video, and computer code).

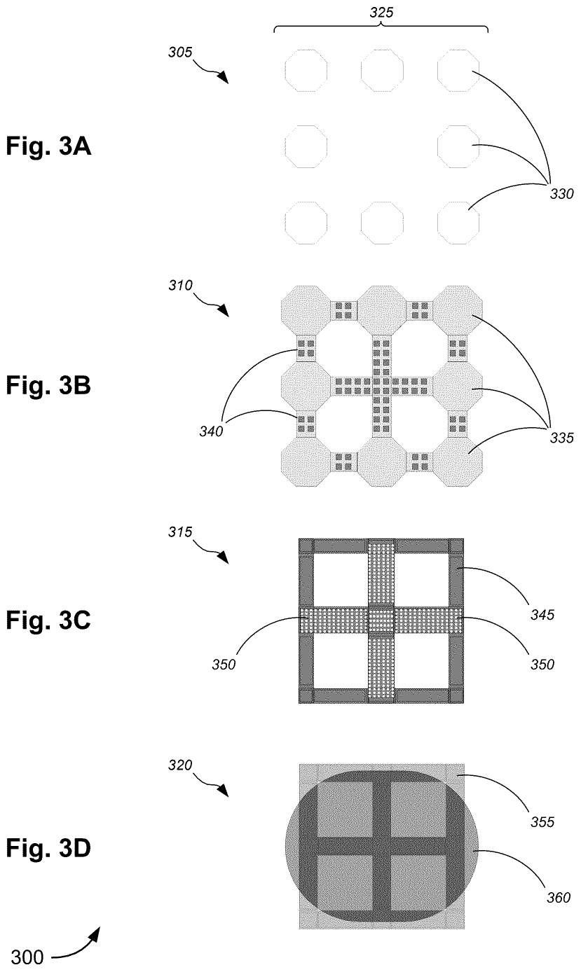

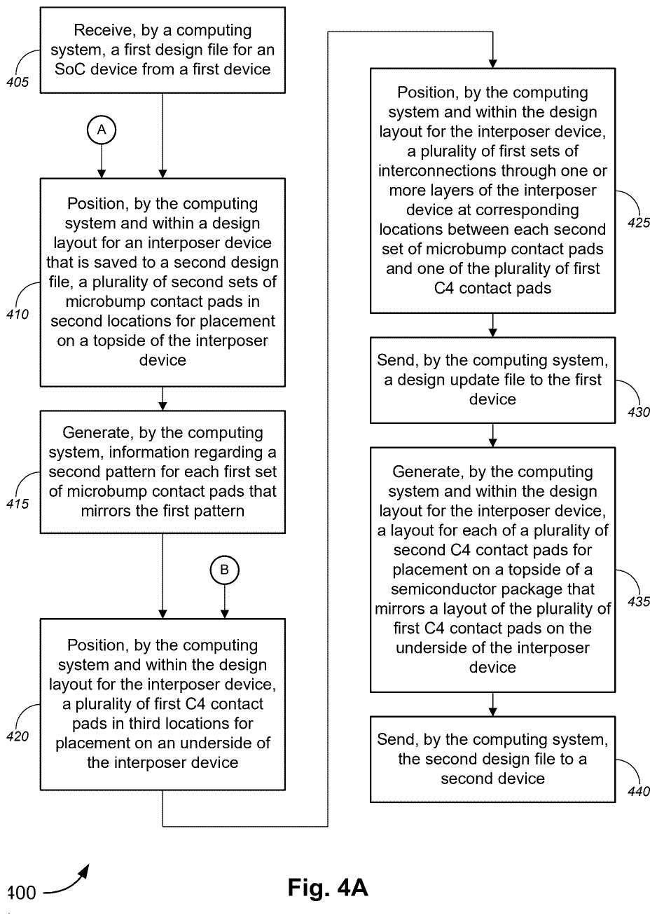

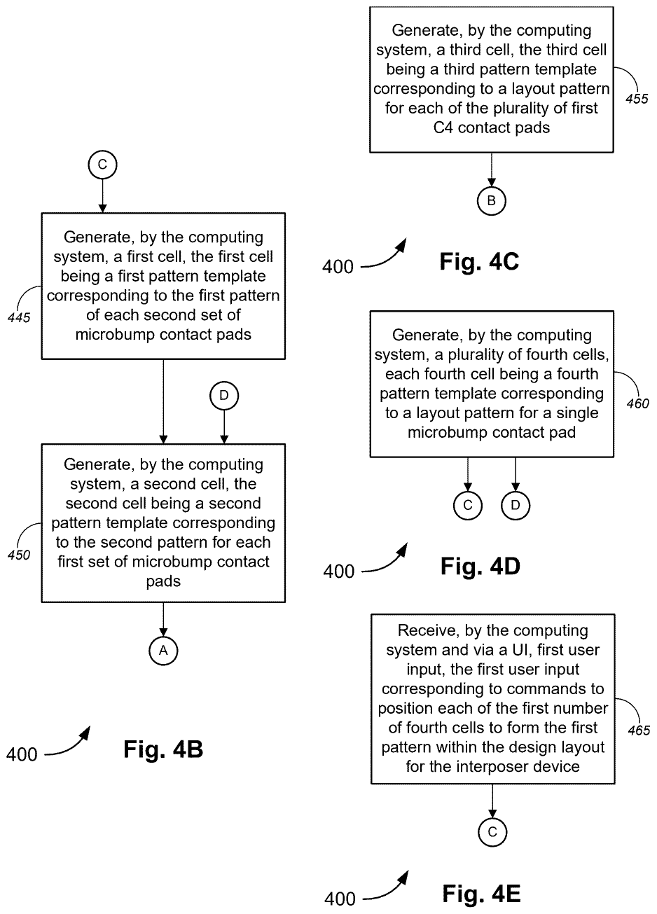

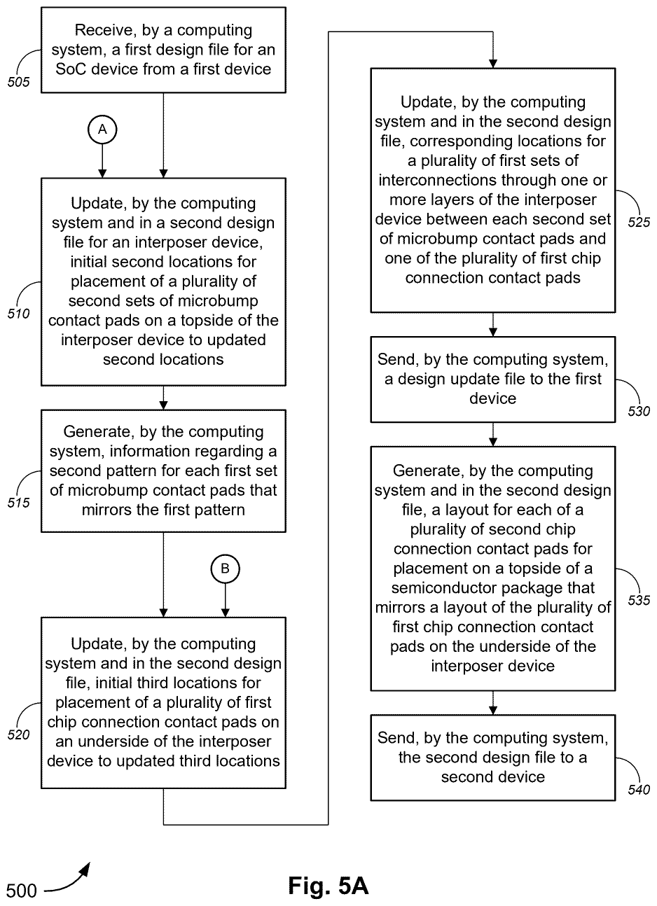

In operation, computing system(s) 115 may perform methods for implementing template cell alignment for interposer layout design, as described in detail with respect to FIGS. 2A-8. For example, example model 200 as described below with respect to FIG. 2 and example template cell alignments 200A-200C as described below with respect to FIGS. 2B-2I, example template cells 300 of FIGS. 3A-3D, and methods 400, 500, 600, 700, and 800 as described below with respect to FIGS. 4, 5, 6, 7, and 8 may be applied with respect to the operations of system 100 of FIG. 1.

In some aspects, instead of using each of microbump contact pad as a separate object in the interposer layout design, and having to ad hoc arrange interconnections (including metal stacking, connectivity in the interposer, and connections to the closest C4 contact pad) in a separate and individual manner for each microbump contact pad, the vertical alignment of microbump contact pad pattern cell for the SoC device, the corresponding microbump contact pad pattern cell for the interposer, the C4 contact pad cell for the interposer, the interconnection pattern cells within the interposer, and the C4 contact pad cell for the semiconductor package are grouped as a pattern cell itself (in this case, a vertically aligned pattern cell). The vertically aligned pattern cell can be replicated multiple times across the interposer layout design for the currently designed IC device, or replicated (as a template vertically aligned pattern cell) across IC device designs for a plurality of different IC devices. Multiple patterns of vertically aligned pattern cells (e.g., some with eight microbump contact pad pattern, some with six microbump contact pad pattern, some with four microbump contact pad patterns in various configurations, some with two microbump contact pad patterns in various configurations, or some with single microbump contact pad patterns in various configurations) with aligned C4 contact pad pattern and corresponding interconnections within the interposer may be saved as template vertically aligned pattern cells, and the template vertically aligned pattern cells may be used as desired or as appropriate in different IC device designs. In this manner, consistency, efficiency, reliability, and reduced complexity are achieved. With such template cells being used, once fabricated and assembled, the IC devices have microbump contact pads and C4 contact pads that are “correct by construction.”

In another aspect, custom bump contact pads are created to connect across an interposer layer stack-up (e.g., the vertical alignment interconnections within the multiple layers of the interposer) and serve as contact devices with an SoC die. The custom bump contact pads include one of the following: (A) a single-pin custom bump contact pad(s) that serves as a contact device(s) from a cluster of microbump contact pads to a C4 contact pad and all layers in between and the complimentary SoC die side microbump contact pad pattern cell; (B) a multi-pin custom bump contact pad(s) that allow for unique terminal arrangements at the interposer and serves as a contact device(s) from a cluster of microbump contact pads to a C4 contact pad and all layers in between and the complimentary SoC die side microbump contact pad pattern cell. This instantiation enables “correct by construction” arrangement between layers, while ensuring netlist connectivity across microbump contact pads to C4 contact pads, as well as adhering to requirements of foundries for overlap and alignment of 2.5D and/or 3D designs, while also minimizing routing complexity and minimizing scenic routing at the interposer level. As used herein, 2.5D refers to a packaging technology where active silicon SoC dies are stacked on a passive interposer. As used herein, netlist refers to a description of the connectivity of an electronic circuit, in this case, connectivity between microbump contact pads on the SoC chip through the interposer to the C4 contact pad on the semiconductor package. As used herein, scenic routing refers to meandering (and typically complicated) trace routes in three dimensions through the interposer layer.

FIG. 2A depicts a sectional elevation view of an example model 200 of an IC device that is manufactured and assembled after implementing template cell alignment for interposer layout design. FIGS. 2B-2E depict example partial sectional top or bottom views of components of the IC device of FIG. 2A for implementing an example template cell alignment 200A for interposer layout design process, as shown along the A-A direction (bottom view), the B-B direction (top view), the C-C direction (bottom view), and the D-D direction (top view), respectively, in FIG. 2A. FIGS. 2F-2I depict alternative example partial sectional top or bottom views of components of the IC device of FIG. 2A for implementing example template cell alignments 200B and 200C for interposer layout design process. In particular, FIGS. 2F and 2G depict an alternative example template cell alignment 200B for interposer layout design process compared with the example template cell alignment 200A of FIGS. 2B and 2C, respectively, while FIGS. 2H and 2I depict an alternative example template cell alignment 200C for interposer layout design process compared with the example template cell alignment 200A of FIGS. 2B and 2C, respectively. Different example implementations of SoC die 205 and interposer 210 are shown in FIGS. 2A-2D and 2F-2I, with a general implementation shown as SoC die 205 and/or interposer 210 in FIGS. 2A and 2D, a first example implementation shown as SoC die 205a and interposer 210a in FIGS. 2B and 2C, respectively, a second example implementation shown as SoC die 205b and interposer 210b in FIGS. 2F and 2G, respectively, and a third example implementation shown as SoC die 205c and interposer 210c in FIGS. 2H and 2I, respectively.

With reference to FIG. 2A, an IC device, as shown in example model 200, includes an SoC die 205, an interposer 210, and a semiconductor package 215 that are vertically stacked with respect to each other, with the interposer 210 being sandwiched or disposed between the SoC die 205 and the semiconductor package 215. The SoC die 205 includes a plurality of microbump contact pads 220a and 220b formed on an underside or bottom surface (or formed in and extending from the bottom surface) of the SoC die 205. The interposer 210 includes a plurality of microbump contact pads 225a and 225b formed on a top side or top surface (or formed in and extending from the top surface) of the interposer 210. As used herein, the terms “topside” (or “top surface”) and “underside” (or “bottom surface”) are used to convey relative directionality for purposes of description of the components and their relative orientations and positions; in actual IC devices in use in real-world environments, the directionality may be flipped, and in some cases (such as where SoC devices are mounted on both sides of the package), directionality of one side is flipped relative to that of the other side. For consistency of description, the semiconductor package is described herein as being below (or down relative to) the SoC die and the interposer. The plurality of microbump contact pads 220a corresponds with, and is formed opposite to, the plurality of microbump contact pads 225a. Likewise, plurality of microbump contact pads 220b corresponds with, and is formed opposite to, the plurality of microbump contact pads 225b. Microbump solder material 230 (also referred to as “microbumps”) is used to join the plurality of microbump contact pads 220a to the plurality of microbump contact pads 225a and to join the plurality of microbump contact pads 220b to the plurality of microbump contact pads 225b, thereby electrically and mechanically joining SoC die 205 to interposer 210.

The interposer 210 further includes interconnections 235 and a plurality of chip connection contact pads (e.g., C4 contact pads) 240a and 240b. The plurality of microbump contact pads 225a electrically connect with chip connection contact pad 240a via interconnections 235a, while the plurality of microbump contact pads 225b electrically connect with chip connection contact pad 240b via interconnections 235b. The semiconductor package 215 includes a plurality of chip connection contact pads 245a and 245b. The chip connection contact pad 240a corresponds with, and is formed opposite to, the chip connection contact pad 245a. Similarly, the chip connection contact pad 240b corresponds with, and is formed opposite to, the chip connection contact pad 245b. Chip connection solder material 250 (also referred to as “C4 bumps” or “C4 balls”) is used to join the chip connection contact pad 240a to the chip connection contact pad 245a and to join the chip connection contact pad 240b to the chip connection contact pad 245b, thereby electrically and mechanically joining the SoC die 205 to the semiconductor package 215. In the example of FIG. 2A, the SoC die 205 is joined to the semiconductor package 215 via a first connection and a second connection that correspond to vertical alignments (the vertical centers of which are highlighted by dashed lines 255a and 255b) extending from the SoC die 205 down through the interposer 210 to the semiconductor package 215. The first connection includes microbump contact pads 220a, microbump solder material 230, microbump contact pads 225a, interconnections 235a, chip connection contact pad 240a, chip connection solder material 250, and chip connection contact pad 245a. The second connection includes microbump contact pads 220b, microbump solder material 230, microbump contact pads 225b, interconnections 235b, chip connection contact pad 240b, chip connection solder material 250, and chip connection contact pad 245b.

Referring to FIGS. 2B-2E, an example template cell alignment 200A is shown in which FIG. 2B depicts an underside of SoC die 205a corresponding to SoC die 205 shown along the A-A direction of FIG. 2A, FIG. 2C depicts a topside of interposer 210a corresponding to interposer 210 shown along the B-B direction of FIG. 2A, FIG. 2D depicts an underside of interposer 210 corresponding to interposer 210 shown along the C-C direction of FIG. 2A, and FIG. 2E depicts a topside of semiconductor package 215 corresponding to semiconductor package 215 shown along the D-D direction of FIG. 2A.

As shown in FIG. 2B, eight microbump contact pads 220a are arranged around a probe pad 260a in a first pattern 265a (in this case, a square pattern or a 3×3 grid pattern with a missing middle piece) corresponding to a template cell pattern that is generated, duplicated, interacted with, modified or manipulated, and/or arranged in a design layout UI (such as design layout UI 150 of FIG. 1). As also shown in FIG. 2B, a pair of microbump contact pads 220b are arranged on either side of a probe pad 260b in a second pattern 265b corresponding to another template cell pattern. The probe pad 260a has an octagonal surface shape, and has an overall side dimension equal to a distance between an inner edge of each of the closest pairs of microbump contact pads 220a (e.g., the pairs that together form a “plus” or “cross” shape). The probe pad 260b has an octagonal surface shape, and has an overall side dimension equal to a distance between an inner edge of the pair of microbump contact pads 220b (e.g., the pair forming a “minus” or “hyphen” shape). In examples, the probe pads 260a and 260b are formed in one of the following configurations: (a) within the bottom surface of SoC die 205a and extending to the bottom surface but not beyond the bottom surface; (b) within the bottom surface of SoC die 205a and extending beyond the bottom surface to the extension height of the microbump contact pads 220a and 220b; (c) within the bottom surface of SoC die 205a and extending beyond the bottom surface to a height that is between the bottom surface and the extension height of the microbump contact pads 220a and 220b; or (d) within the bottom surface of SoC die 205a and covered by dielectric material of SoC die 205.

As shown in FIG. 2C, eight microbump contact pads 225a are arranged in a third pattern 275a (in this case, a square pattern or a 3×3 grid pattern with a missing middle piece) with rectangular traces 270a (in this case, a grid pattern with rectangular traces connecting adjacent microbump contact pads 225a along the edges of the third pattern, and forming a cross or plus shape in the middle). As also shown in FIG. 2C, a pair of microbump contact pads 225b are arranged in a fourth pattern 275b with a rectangular trace connecting the pair of microbump contact pads 225b (in this case, forming a dumbbell shape). The third and fourth patterns 275a and 275b each corresponds to a template cell pattern that is also generated, duplicated, interacted with, modified or manipulated, and/or arranged in the design layout UI (such as design layout UI 150 of FIG. 1). In examples, the rectangular traces 270a and 270b correspond to interconnections 235 that are formed in one of the following configurations: (a) within the top surface of interposer 210a and extending to the top surface but not beyond the top surface; (b) within the top surface of interposer 210a and extending beyond the top surface to the extension height of the microbump contact pads 225a and 225b; (c) within the top surface of interposer 210a and extending beyond the top surface to a height that is between the top surface and the extension height of the microbump contact pads 225a and 225b; or (d) within the top surface of interposer 210a and covered by dielectric material of interposer 210a.

Referring to FIG. 2D, bottom surfaces of a multi-pin interconnection(s) 235a (corresponding to interconnection(s) 235a of FIG. 2A) is shown within a circular probe pad 280a, which is shown within an oval-shaped chip connection contact pad 240a in a fifth pattern 285a. As also shown in FIG. 2E, a bottom surface of a single-pin interconnection(s) 235b (corresponding to interconnection(s) 235b of FIG. 2A) is shown within a circular probe pad 280b, which is shown within an oval-shaped chip connection contact pad 240b in a sixth pattern 285b. In some examples, the circular probe pad 280a and the circular probe pad 280b each corresponds to interconnection(s) 235 shown in FIG. 2A. In examples, the multi-pin interconnection(s) 235a (in this case, a two-pin interconnection), the single-pin interconnection(s) 235b, the circular probe pad 280a, and the circular probe pad 280b each is formed in one of the following configurations: (a) within the bottom surface of interposer 210 and extending to the bottom surface but not beyond the bottom surface; (b) within the bottom surface of interposer 210 and extending beyond the bottom surface to the extension height of the chip connection contact pads 240a and 240b; (c) within the bottom surface of interposer 210 and extending beyond the bottom surface to a height that is between the bottom surface and the extension height of the chip connection contact pads 240a and 240b; (d) within the bottom surface of interposer 210 and covered by dielectric material of interposer 210; or (e) extending from within the interposer 210, through the chip connection contact pads 240a and 240b, into at least a portion of the chip connection solder material 250.

Turning to FIG. 2E, a circular probe pad 290a is shown within an oval-shaped chip connection contact pad 245a in a seventh pattern 295a. As also shown in FIG. 2E, a circular probe pad 290b is shown within an oval-shaped chip connection contact pad 245b in an eighth pattern 295b. In examples, the circular probe pad 290a and the circular probe pad 290b each is formed in one of the following configurations: (a) within the top surface of semiconductor package 215 and extending to the top surface but not beyond the top surface; (b) within the top surface of semiconductor package 215 and extending beyond the top surface to the extension height of the chip connection contact pads 245a and 245b; (c) within the top surface of semiconductor package 215 and extending beyond the top surface to a height that is between the top surface and the extension height of the chip connection contact pads 245a and 245b; or (d) within the top surface of semiconductor package 215 and covered by dielectric material of semiconductor package 215.

With reference to FIGS. 2A-2E, when assembled as shown in the sectional elevation view of FIG. 2A, the centers of the first pattern 265a in the sectional bottom view FIG. 2B (in this case, the center of probe pad 260a), the third pattern 275a in the top view of FIG. 2C (in this case, the center of interconnections 270a), the fifth pattern 285a in the bottom view of FIG. 2D (in this case, the center of probe pad 280a), and the seventh pattern 295a in the top view of FIG. 2E (in this case, the center of probe pad 290a) are vertically aligned, to within a tolerance value (e.g., about 1 to about 5 mm, about 750 micrometers (mm), about 500 mm, about 250 mmm, about 100 mm, about 75 mm, about 50 mm, or about 25 mm), along the dashed line 255a shown in FIG. 2A. The first pattern 265a and the third pattern 275a are companion patterns that mirror each other, with the pattern cells they are based on in the design layout UI 110 being companion pattern cells that likewise mirror each other. Similarly, the fifth pattern 285a and the seventh pattern 295a are companion patterns that mirror each other, with the pattern cells they are based on in the design layout UI 110 being companion pattern cells that likewise mirror each other. Likewise, when assembled as shown in the sectional elevation view of FIG. 2A, the centers of the second pattern 265b in the sectional bottom view FIG. 2B (in this case, the center of probe pad 260b), the fourth pattern 275b in the top view of FIG. 2C (in this case, the center of interconnections 270b), the sixth pattern 285b in the bottom view of FIG. 2D (in this case, the center of probe pad 280b), and the eighth pattern 295b in the top view of FIG. 2E (in this case, the center of probe pad 290b) are vertically aligned, to within the tolerance value, along the dashed line 255b shown in FIG. 2A. The second pattern 265b and the fourth pattern 275b are companion patterns that mirror each other, with the pattern cells they are based on in the design layout UI 110 being companion pattern cells that likewise mirror each other. Similarly, the sixth pattern 285b and the eighth pattern are companion patterns that mirror each other, with the pattern cells they are based on in the design layout UI 110 being companion pattern cells that likewise mirror each other. This corresponds to the vertical alignment of the corresponding template cells in the UI during design of at least the interposer and requests to modify the designs of the SoC die/chip and the semiconductor package to align with the microbump contact pads and the chip connect contact pads of the interposer, which are aligned within the UI together with the interconnections in the interposer, in some cases, using the cell alignment tool(s) 160, the visualization tool(s) 165, and/or the AI system(s) 170 of computing system 115 of FIG. 1. The tolerance values described above accounts for physical inaccuracies in alignment during assembly of the IC device, despite accurate vertical alignment of the pattern cells in the design layout UI 110.

Referring to FIGS. 2F and 2G, another example template cell alignment 200B is shown in which FIG. 2F depicts an underside of SoC die 205b corresponding to an alternative example compared with the underside of SoC die 205a of FIG. 2B, and FIG. 2G depicts a topside of interposer 210b corresponding to an alternative example compared with the topside of interposer 210a of FIG. 2C. Rather than the eight microbump contact pads 220a of the first pattern 265a in FIG. 2B, in FIG. 2F, four microbump contact pads 220a are arranged around probe pad 260a in a ninth pattern 265c (in this case, a cross or plus pattern). Similarly, as also shown in FIG. 2F, instead of the pair of microbump contact pads 220b of the second pattern 265b in FIG. 2B, three pairs of microbump contact pads 220b are arranged with one side of each pair on a first side of the probe pad 260b and with the other side of each pair on a second side of the probe pad 260b opposite the first side in a tenth pattern 265d (or with six microbump contact pads 220b having half aligned to the left of probe pad 260b and the other half aligned to the right of probe pad 260b). Correspondingly, in FIG. 2G, rather than the eight microbump contact pads 225a of the third pattern 275a in FIG. 2C, four microbump contact pads 225a are arranged on the ends of plus-shaped or cross-shaped interconnections 265a in an eleventh pattern 275c (in this case, a cross or plus pattern). Likewise, as also shown in FIG. 2G, instead of the pair of microbump contact pads 225b of the fourth pattern 275b in FIG. 2C, six microbump contact pads 225b are arranged in a twelfth pattern 275d with rectangular traces connecting the six microbump contact pads in a ladder formation or a block-shaped number eight formation. The ninth, tenth, eleventh, and twelfth patterns 265c, 265d, 275c, and 275d each corresponds to another template cell pattern that is also generated, duplicated, interacted with, modified or manipulated, and/or arranged in the design layout UI (such as design layout UI 150 of FIG. 1). The ninth, tenth, eleventh, and twelfth patterns 265c, 265d, 275c, and 275d are otherwise similar, if not identical, to the first, second, third, and fourth patterns 265a, 265b, 275a, and 275b, respectively.

Alternatively, with reference to FIGS. 2H and 2I, another example template cell alignment 200C is shown in which FIG. 2H depicts an underside of SoC die 205c corresponding to an alternative example compared with the underside of SoC die 205a of FIG. 2B, and FIG. 2I depicts a topside of interposer 210c corresponding to an alternative example compared with the topside of interposer 210a of FIG. 2C. Rather than the eight microbump contact pads 220a of the first pattern 265a in FIG. 2B, in FIG. 2H, four microbump contact pads 220a are arranged around probe pad 260a in a thirteenth pattern 265e (in this case, a square pattern with microbump contact pads 220a only at the corners, surrounding the probe pad 260a in the middle). Similarly, as also shown in FIG. 2H, instead of the pair of microbump contact pads 220b of the second pattern 265b in FIG. 2B, four microbump contact pads 220b are arranged with two on a first or left side of the probe pad 260b and with another two on a second or right side of the probe pad 260b opposite the first side in a fourteenth pattern 265f (in this case, in a stepped pattern, stepping downward to the right). Correspondingly, in FIG. 2I, rather than the eight microbump contact pads 225a of the third pattern 275a in FIG. 2C, four microbump contact pads 225a are arranged in a fifteenth pattern 275e with rectangular traces 265a joining two adjacent microbump contact pads 225a on the outer edges (in this case, a square pattern with microbump contact pads 220a only at the corners and rectangular traces 265a forming the sides of the square). Likewise, as also shown in FIG. 2I, instead of the pair of microbump contact pads 225b of the fourth pattern 275b in FIG. 2C, four microbump contact pads 225b are arranged in a sixteenth pattern 275f with rectangular traces connecting the four microbump contact pads in a stepped pattern, stepping upward to the right. The thirteenth, fourteenth, fifteenth, and sixteenth patterns 265e, 265f, 275e, and 275f each corresponds to another template cell pattern that is also generated, duplicated, interacted with, modified or manipulated, and/or arranged in the design layout UI (such as design layout UI 150 of FIG. 1). The thirteenth, fourteenth, fifteenth, and sixteenth patterns 265e, 265f, 275e, and 275f are otherwise similar, if not identical, to the first, second, third, and fourth patterns 265a, 265b, 275a, and 275b, respectively.

Although FIGS. 2A-2I depict the IC device having one SoC die 205, one interposer 210, and one semiconductor package 215, the IC device may have any number of SoC dies (corresponding to SoC devices) being mounted on a single semiconductor package via any suitable number of interposers, where any one interposer can connect one or a multiple of SoC dies to the single semiconductor package, but an SoC die is not connected to the semiconductor package via more than one interposer. Although FIGS. 2A-2I depict two side-by-side vertical alignments (the vertical centers of which are highlighted by dashed lines 255a and 255b) extending from SoC die down through the interposer to the semiconductor package, any suitable number of vertical alignments may be used to extend from the SoC die down through the interposer to the semiconductor package. Although FIGS. 2B-2I depict components having particular sizes and geometrical shapes (e.g., microbump contact pads 220a, 220b, 225a, and 225b each having an octagonal surface shape, probe pads 260a and 260b each also having an octagonal surface shape, pin interconnects 235a and 235b each having an cylindrical shape, probe pads 280a, 280b, 290a, and 290b each having a circular surface shape, chip connection contact pads 240a, 240b, 245a, and 245b each having an oval surface shape, and contact pad interconnects 265a and 265b each having rectangular traces that in some cases join with each other to form other polygonal shapes), such components may have any suitable sizes or geometrical shapes. In some examples, rectangular traces 270a and 270b (as shown, e.g., in FIGS. 2C, 2G, and 2I) are disposed on the topside surface of the interposer (e.g., interposer 210a, 210b, and 210c of FIGS. 2C, 2G, and 2I, respectively). In other examples, rectangular traces 270a and 270b are disposed under the topside surface of the interposer, in some cases with dielectric material disposed on the topside surface, above (or covering) the rectangular traces 270a and 270b. Similarly, in some examples, interconnections 235a and 235b (as shown in FIG. 2D) are disposed on the underside surface of the interposer (e.g., interposer 210). In other examples, the interconnections 235a and 235b are disposed above the underside surface of the interposer (i.e., within the interposer), in some cases with dielectric material disposed on the underside surface, covering the interconnections 235a and 235b.

FIGS. 3A-3D depict example template cells 305, 310, 315, and 320, respectively, for different interposer layers that are aligned vertically within an interposer device when implementing template cell alignment for interposer layout design. Example template cells 305, 310, 315, and 320 correspond to vertically-aligned patterns 325. In FIG. 3A, template cell 305 corresponds to a first pattern of microbump contact pads 330 on a first layer at a topside surface of the interposer device (e.g., interposer 210, 210a, 210, or 210c of FIGS. 2A-2I). In FIG. 3B, template cell 310 corresponds to a second pattern for a redistribution layer (“RDL”) at a second layer below the first layer. The second pattern includes a pattern of microbump contact pad interfaces 335 (which interface with corresponding microbump contact pads (e.g., microbump contact pads 225a or 225b of FIGS. 2A-2I)) and a pattern of vias 340. In FIG. 3C, template cell 315 corresponds to a third pattern for one of a plurality of intermediate layers below the first and second layers. The third pattern includes a pattern of intermediate layer interconnection traces 345 and a pattern of vias 350. In FIG. 3D, template cell 320 corresponds to a fourth pattern at a fourth layer that is below the plurality of intermediate layers and between the plurality of intermediate layers and an underside surface of the interposer device. The fourth pattern includes a pattern of interconnection traces 355 for the fourth layer and a pattern of a chip connection contact pad interface 360, which interface with corresponding chip connection contact pads (e.g., chip connection contact pads 240a or 240b of FIGS. 2A and 2D).

FIGS. 4A-4E depict an example method 400 for implementing template cell alignment for interposer layout design. With reference to FIGS. 4A-4E, the operations of example method 400 may be performed by a computing system (e.g., computing system 115 of FIG. 1). Method 400 of FIG. 4B continues onto FIG. 4A following the circular marker denoted, “A.” Method 400 of FIG. 4C continues onto FIG. 4A following the circular marker denoted, “B.” Method 400 of FIG. 4D continues onto FIG. 4B either following the circular marker denoted, “C,” or following the circular marker denoted, “D.” Method 400 of FIG. 4D continues onto FIG. 4B following the circular marker denoted, “C.”

In the example method 400 of FIG. 4, at operation 405, a computing system receives a first design file for an SoC device from a first device. In examples, the first design file includes first data indicating initial first locations for placement of a plurality of first sets of microbump contact pads on an underside of a die corresponding to the SoC device. At operation 410, the computing system positions, within a design layout for an interposer device that is saved to a second design file, a plurality of second sets of microbump contact pads in second locations for placement on a topside of the interposer device. In examples, the second locations align with one of the initial first locations or updated first locations when the SoC device is mounted on the interposer device. Each of the second sets of microbump contact pads is arranged in a first pattern. At operation 415, the computing system generates information regarding a second pattern for each first set of microbump contact pads that mirrors the first pattern. At operation 420, the computing system positions, within the design layout for the interposer device, a plurality of first C4 contact pads in third locations for placement on an underside of the interposer device.

In examples, the computing system positions, within the design layout for the interposer device, a plurality of first sets of interconnections through one or more layers of the interposer device at corresponding locations between each second set of microbump contact pads and one of the plurality of first C4 contact pads (at operation 425). In examples, a center of each of the first pattern of each second set of microbump contact pads and a center of a corresponding one of the plurality of first C4 contact pads are aligned vertically. At operation 430, the computing system sends a design update file to the first device, the design update file including second data. In some examples, the second data includes the second locations of the plurality of second sets of microbump contact pads and the information regarding the second pattern for each first set of microbump contact pads that mirrors the first pattern. At operation 435, the computing system generates, within the design layout for the interposer device, a layout for each of a plurality of second C4 contact pads for placement on a topside of a semiconductor package that mirrors a layout of the plurality of first C4 contact pads on the underside of the interposer device. At operation 440, the computing system sends the second design file to a second device, the second design file including third data. In some examples, the third data includes fourth locations of the plurality of first C4 contact pads and the layout for each of the plurality of second C4 contact pads for placement on the topside of the semiconductor package.

In examples, the first device is an SoC design system, while the second device is a semiconductor package design system. In some examples, the plurality of first C4 contact pads and the plurality of second C4 contact pads are each C4 contact pads.

Referring to FIG. 4B, at operation 445, method 400 includes the computing system generating a first cell, the first cell being a first pattern template corresponding to the first pattern of each second set of microbump contact pads. At operation 450, the computing system generates a second cell, the second cell being a second pattern template corresponding to the second pattern for each first set of microbump contact pads. In some cases, the information regarding the second pattern includes the second cell. Method 400 continues onto the process at operation 410 following the circular marker denoted, “A,” where positioning the plurality of second sets of microbump contact pads in the second locations (at operation 410) includes moving, within the design layout for the interposer device, the first cell corresponding to each of the plurality of second sets of microbump contact pads from initial second locations to the second locations.

Turning to FIG. 4C, method 400, at operation 455, includes the computing system generating a third cell, the third cell being a third pattern template corresponding to a layout pattern for each of the plurality of first C4 contact pads. Method 400 continues onto the process at operation 420 following the circular marker denoted, “B,” where positioning the plurality of first C4 contact pads in the third locations (at operation 420) includes moving, within the design layout for the interposer device, the third cell corresponding to each of the plurality of first C4 contact pads from initial third locations to the third locations. In examples, vertical alignment of the center of the first pattern of each second set of microbump contact pads and the center of the corresponding one of the plurality of first C4 contact pads includes aligning the first cell to overlap a corresponding third cell within the design layout for the interposer device.

With reference to FIG. 4D, at operation 460, method 400 further includes the computing system generating a plurality of fourth cells, each fourth cell being a fourth pattern template corresponding to a layout pattern for a single microbump contact pad. Method 400 continues onto the process at operation 445 following the circular marker denoted, “C,” where generating the first cell (at operation 445) includes arranging a first number of fourth cells in the first pattern, and/or continues onto the process at operation 450 following the circular marker denoted, “D,” where generating the second cell (at operation 450) includes arranging the first number of fourth cells in the second pattern.

Referring to FIG. 4E, method 400, at operation 465, includes the computing system receiving first user input, via a UI, the first user input corresponding to commands to position each of the first number of fourth cells to form the first pattern within the design layout for the interposer device. Method 400 continues onto the process at operation 445 following the circular marker denoted, “C,” where generating the first cell (at operation 445) includes arranging the first number of fourth cells in the first pattern based on the first user input.

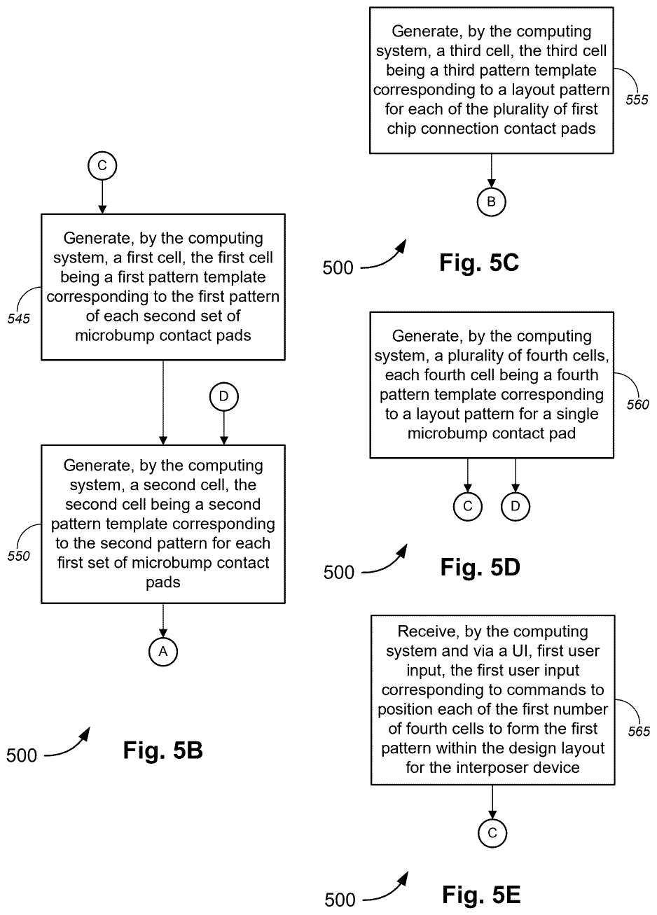

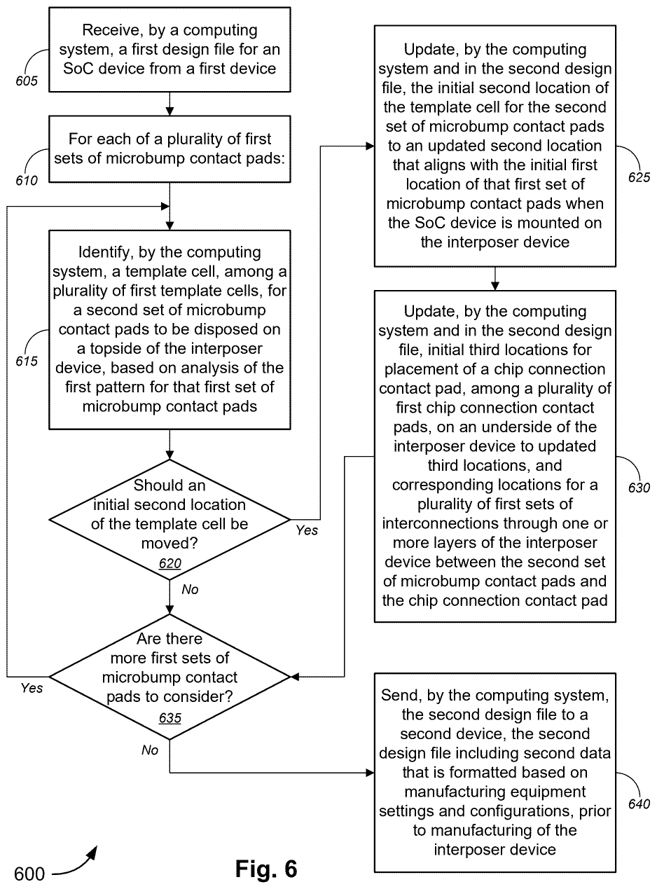

FIGS. 5A-5E depict another example method 500 for implementing template cell alignment for interposer layout design. Referring to FIGS. 5A-5E, the operations of example method 500 may be performed by a computing system (e.g., computing system 115 of FIG. 1). Method 500 of FIG. 5B continues onto FIG. 5A following the circular marker denoted, “A.” Method 500 of FIG. 5C continues onto FIG. 5A following the circular marker denoted, “B.” Method 500 of FIG. 5D continues onto FIG. 5B either following the circular marker denoted, “C,” or following the circular marker denoted, “D.” Method 500 of FIG. 5D continues onto FIG. 5B following the circular marker denoted, “C.”

In the example method 500 of FIG. 5, at operation 505, a computing system receives a first design file for an SoC device from a first device. In examples, the first design file includes first data indicating initial first locations for placement of a plurality of first sets of microbump contact pads on an underside of a die corresponding to the SoC device. At operation 510, the computing system updates, in a second design file for an interposer device, initial second locations for placement of a plurality of second sets of microbump contact pads on a topside of the interposer device to updated second locations that align with one of the initial first locations or updated first locations when the SoC device is mounted on the interposer device. Each of the second sets of microbump contact pads is arranged in a first pattern. At operation 515, the computing system generates information regarding a second pattern for each first set of microbump contact pads that mirrors the first pattern. At operation 520, the computing system updates, in the second design file, initial third locations for placement of a plurality of first chip connection contact pads on an underside of the interposer device to updated third locations.

In examples, the computing system updates, in the second design file, corresponding locations for a plurality of first sets of interconnections through one or more layers of the interposer device between each second set of microbump contact pads and one of the plurality of first chip connection contact pads (at operation 525). In examples, a center of each of the first pattern of each second set of microbump contact pads and a center of a corresponding one of the plurality of first chip connection contact pads are aligned vertically. At operation 530, the computing system sends a design update file to the first device, the design update file including second data. In some examples, the second data includes the updated second locations of the plurality of second sets of microbump contact pads and the information regarding the second pattern for each first set of microbump contact pads that mirrors the first pattern. At operation 535, the computing system generates, in the second design file, a layout for each of a plurality of second chip connection contact pads for placement on a topside of a semiconductor package that mirrors a layout of the plurality of first chip connection contact pads on the underside of the interposer device. At operation 540, the computing system sends the second design file to a second device, the second design file including third data. In some examples, the third data includes fourth locations of the plurality of first chip connection contact pads and the layout for each of the plurality of second chip connection contact pads for placement on the topside of the semiconductor package.

In examples, the first device is an SoC design system, while the second device is a semiconductor package design system. In some examples, the plurality of first chip connection contact pads and the plurality of second chip connection contact pads are each C4 contact pads. In examples, updating the initial second locations to the updated second locations (at operation 510) includes:
(a) calculating a first set of 2D coordinates for each of the plurality of first sets of microbump contact pads relative to a reference point within the design layout for the interposer device;
(b) calculating a second set of 2D coordinates for each of the plurality of second sets of microbump contact pads relative to the reference point within the design layout for the interposer device;
(c) calculating a 2D shift amount based on a difference between the first set of 2D coordinates and the second set of 2D coordinates; and
(d) moving, within the design layout for the interposer device, each second set of microbump contact pads from a corresponding one of the initial second locations to a corresponding one of the updated second locations by the 2D shift amount.

In some examples, updating the initial third locations to the updated third locations (at operation 530) includes moving, within the design layout for the interposer device, each first chip connection contact pad from a corresponding one of the initial third locations to a corresponding one of the updated third locations by the 2D shift amount.

Referring to FIG. 5B, at operation 545, method 500 includes the computing system generating a first cell, the first cell being a first pattern template corresponding to the first pattern of each second set of microbump contact pads. At operation 550, the computing system generates a second cell, the second cell being a second pattern template corresponding to the second pattern for each first set of microbump contact pads. In some cases, the information regarding the second pattern includes the second cell. Method 500 continues onto the process at operation 510 following the circular marker denoted, “A,” where updating the initial second locations to the updated second locations (at operation 510) includes moving the first cell corresponding to each of the plurality of second sets of microbump contact pads within a design layout for the interposer device that is saved to the second design file.

Turning to FIG. 5C, method 500, at operation 555, includes the computing system generating a third cell, the third cell being a third pattern template corresponding to a layout pattern for each of the plurality of first chip connection contact pads. Method 500 continues onto the process at operation 520 following the circular marker denoted, “B,” where updating the initial third locations to the updated third locations (at operation 520) includes moving the third cell corresponding to each of the plurality of first chip connection contact pads within the design layout for the interposer device. In examples, vertical alignment of the center of the first pattern of each second set of microbump contact pads and the center of the corresponding one of the plurality of first chip connection contact pads includes aligning the first cell to overlap a corresponding third cell within the design layout for the interposer device.

With reference to FIG. 5D, at operation 560, method 500 further includes the computing system generating a plurality of fourth cells, each fourth cell being a fourth pattern template corresponding to a layout pattern for a single microbump contact pad. Method 500 continues onto the process at operation 545 following the circular marker denoted, “C,” where generating the first cell (at operation 545) includes arranging a first number of fourth cells in the first pattern, and/or continues onto the process at operation 550 following the circular marker denoted, “D,” where generating the second cell (at operation 550) includes arranging the first number of fourth cells in the second pattern.

Referring to FIG. 5E, method 500, at operation 565, includes the computing system receiving first user input, via a UI, the first user input corresponding to commands to position each of the first number of fourth cells to form the first pattern within the design layout for the interposer device. Method 500 continues onto the process at operation 545 following the circular marker denoted, “C,” where generating the first cell (at operation 545) includes arranging the first number of fourth cells in the first pattern based on the first user input.

FIG. 6 depicts yet another example method 600 for implementing template cell alignment for interposer layout design. Referring to FIG. 6, the operations of example method 600 may be performed by a computing system (e.g., computing system 115 of FIG. 1).

In the example method 600 of FIG. 6, at operation 605, a computing system receives a first design file for an SoC device from a first device. In examples, the first design file includes first data indicating, for each of a plurality of first sets of microbump contact pads, a first pattern of microbump contact pads and an initial first location for placement of that first set of microbump contact pads on an underside of a die corresponding to the SoC device. At operation 510, the computing system. At operation 610, for each of the plurality of first sets of microbump contact pads, the computing system performs operations 615-635. At operation 615, the computing system identifies a template cell, among a plurality of first template cells, for a second set of microbump contact pads to be disposed on a topside of the interposer device, based on an analysis of the first pattern for that first set of microbump contact pads. In examples, the template cell is a pattern template corresponding to a second pattern of microbump contact pads for the second set of microbump contact pads. At operation 620, the computing system determines whether an initial second location of the template cell for the second set of microbump contact pads, within a second design file for the interposer device, should be moved to vertically align with that first set of microbump contact pads when the SoC device is mounted on the interposer device, based on an analysis of the initial first location for that first set of microbump contact pads. Based on a determination that the initial second location should be moved, method 600 continues onto the process at operation 625. Based on a determination that the initial second location need not be moved, method 600 continues onto the process at operation 635.

At operation 625, the computing system updates, in the second design file, the initial second location of the template cell for the second set of microbump contact pads to an updated second location that aligns with the initial first location of that first set of microbump contact pads when the SoC device is mounted on the interposer device. At operation 630, the computing system updates, in the second design file, initial third locations for placement of a chip connection contact pad, among a plurality of first chip connection contact pads, on an underside of the interposer device to updated third locations, and corresponding locations for a plurality of first sets of interconnections through one or more layers of the interposer device between the second set of microbump contact pads and the chip connection contact pad. In examples, a center of the first pattern of that first set of microbump contact pads, a center of the second set of microbump contact pads, and a center of the chip connection contact pad are aligned vertically. Method 600 continues onto the process at operation 635.

At operation 635, the computing system determines whether there are more first sets of microbump contact pads to consider. Based on a determination that there are more first sets of microbump contact pads to consider, method 600 returns to the process at operation 615. Based on a determination that there are no more first sets of microbump contact pads to consider, method 600 continues onto the process at operation 640. At operation 640, the computing system sends the second design file to a second device. In some examples, the second design file includes second data that is formatted based on manufacturing equipment settings and configurations, prior to manufacturing of the interposer device. In examples, the second device includes an IC design system (e.g., IC design system(s) 125 of FIG. 1) or an IC foundry system (e.g., IC foundry system(s) 145 of FIG. 1).

In some examples, the computing system generates a first cell, the first cell being a first pattern template corresponding to the first pattern of each first set of microbump contact pads. The computing system generates a second cell, the second cell being a second pattern template corresponding to the second pattern for each second set of microbump contact pads. In examples, updating the initial second locations to the updated second locations includes moving the second cell corresponding to each of the plurality of second sets of microbump contact pads within a design layout for the interposer device that is saved to the second design file. In some examples, the computing system generates a third cell, the third cell being a third pattern template corresponding to a layout pattern for each of the plurality of first chip connection contact pads. In examples, updating the initial third locations to the updated third locations includes moving the third cell corresponding to each of the plurality of first chip connection contact pads within the design layout for the interposer device. In some examples, vertical alignment of the center of the first pattern of each second set of microbump contact pads and the center of the corresponding one of the plurality of first chip connection contact pads includes aligning the second cell to overlap a corresponding third cell within the design layout for the interposer device.

In examples, the computing system generates a plurality of fourth cells, each fourth cell being a fourth pattern template corresponding to a layout pattern for a single microbump contact pad. In some instances, generating the first cell includes arranging a first number of fourth cells in the first pattern. In some cases, generating the second cell includes arranging the first number of fourth cells in the second pattern. In some examples, the computing system receives first user input, via a UI(s) (e.g., UI(s) 110 of FIG. 1), the first user input corresponding to commands to position each of the first number of fourth cells to form the second pattern within the design layout for the interposer device. In some instances, generating the second cell includes arranging the first number of fourth cells in the second pattern based on the first user input. In some examples, updating the initial second location to the updated second location and updating the initial third location to the updated third location include, for each of the plurality of first sets of microbump contact pads:
(a) calculating a first set of 2D coordinates for that first set of microbump contact pads relative to a reference point within the design layout for the interposer device;
(b) calculating a second set of 2D coordinates for the second set of microbump contact pads relative to the reference point within the design layout for the interposer device;
(c) calculating a direction and a 2D shift amount based on a difference between the first set of 2D coordinates and the second set of 2D coordinates;
(d) moving, within the design layout for the interposer device, the second set of microbump contact pads from the initial second location to the updated second locations by the 2D shift amount in the calculated direction; and
(e) moving, within the design layout for the interposer device, the chip connection contact pad from the initial third location to the updated third location by the 2D shift amount in the calculated direction.

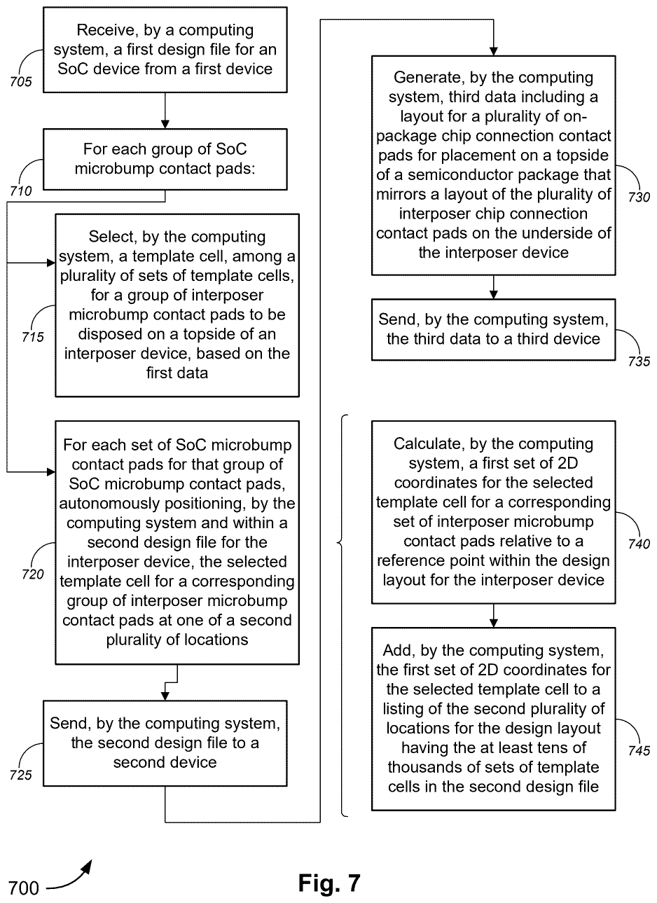

FIG. 7 depicts still another example method 700 for implementing template cell alignment for interposer layout design. Referring to FIG. 7, the operations of example method 700 may be performed by a computing system (e.g., computing system 115 of FIG. 1).

In the example method 700 of FIG. 7, at operation 705, a computing system receives a first design file for an SoC device from a first device. In examples, the first design file includes first data indicating a first plurality of locations of a plurality of groups of SoC microbump contact pads. In some cases, each group of SoC microbump contact pads has a plurality of sets of SoC microbump contact pads with each set in that group having an identical pattern of SoC microbump contact pads as that of other sets in that group. In some instances, each set of SoC microbump contact pads has a central point and two or more SoC microbump contact pads arranged in a pattern centered relative to that central point. In some examples, the pattern of SoC microbump contact pads for each group of SoC microbump contact pads has a different combination of number and arrangement of SoC microbump contact pads compared with other groups of SoC microbump contact pads. In examples, the first plurality of locations corresponds to placement of the plurality of sets of SoC microbump contact pads for each group of SoC microbump contact pads on an underside of a die corresponding to the SoC device.

For each group of SoC microbump contact pads (at operation 710), the computing system selects a template cell, among a plurality of sets of template cells, for a group of interposer microbump contact pads to be disposed on a topside of an interposer device, based on the first data (at operation 715); and for each set of SoC microbump contact pads for that group of SoC microbump contact pads, autonomously positioning, within a second design file for the interposer device, the selected template cell for a corresponding group of interposer microbump contact pads at one of a second plurality of locations (at operation 720). In examples, the template cell includes a pattern of interposer microbump contact pads that mirrors the pattern of SoC microbump contact pads for that group of SoC microbump contact pads in terms of a combination of number and arrangement of interposer microbump contact pads compared with that group of SoC microbump contact pads. In some cases, each template cell further includes a pattern of interposer chip connection contact pads and a pattern of a set of interconnections through one or more layers of the interposer device between the interposer microbump contact pads and the interposer chip connection contact pads for that template cell. In some instances, a center of the pattern of interposer microbump contact pads, a center of the pattern of the interposer chip connection contact pads, and a center of the pattern of the set of interconnections for that template cell are aligned vertically with each other. In some examples, autonomously positioning the selected template cell at one of the second plurality of locations results in the interposer microbump contact pads for that group of interposer microbump contact pads being vertically aligned with the SoC microbump contact pads for that set of SoC microbump contact pads when the SoC device is mounted on the interposer device. In some instances, placement of the selected template cell corresponds to placement of the interposer chip connection contact pads for that template cell, among a plurality of interposer chip connection contact pads, on an underside of the interposer device.

At operation 725, the computing system sends the second design file to a second device. In some examples, the second design file includes second data that is formatted based on manufacturing equipment settings and configurations, prior to manufacturing of the interposer device. In examples, the computing system generates third data including a layout for a plurality of on-package chip connection contact pads for placement on a topside of a semiconductor package that mirrors a layout of the plurality of interposer chip connection contact pads on the underside of the interposer device (at operation 730). The computing system sends the third data to a third device (at operation 735). In some examples, the third device associated with manufacturing equipment that is used to produce the semiconductor package with the plurality of on-package chip connection contact pads is positioned on the topside of the semiconductor package, based on the layout. In some cases, the first device is an SoC design system, the second device is a semiconductor package design system, and the plurality of interposer chip connection contact pads and the plurality of on-package chip connection contact pads are each a corresponding plurality of C4 contact pads.

In examples, the first data further includes a listing of each set of SoC microbump contact pads for each group of SoC microbump contact pads together with corresponding locations among the first plurality of locations. In some cases, the first data is directed to a layout having at least tens of thousands of sets of SoC microbump contact pads among the plurality of groups of SoC microbump contact pads, while the second data is directed to a design layout having a corresponding at least tens of thousands of sets of template cells. In some instances, the first data further includes an indication of a connection label corresponding to a designed purpose and functionality (e.g., one of power, ground, or signal connection in general, or a specific one of power, ground, or signal connection) for each interposer chip connection contact pad listed together with a corresponding one of the plurality of sets of SoC microbump contact pads and the corresponding locations among the first plurality of locations. In some examples, autonomously positioning, within the second design file for the interposer device, the selected template cell for each set of SoC microbump contact pads for that group of SoC microbump contact pads (at operation 720) includes, for that set of SoC microbump contact pads:
(A) calculating a first set of 2D coordinates for the selected template cell for a corresponding set of interposer microbump contact pads relative to a reference point within the design layout for the interposer device (at operation 740); and
(B) adding the first set of 2D coordinates for the selected template cell to a listing of the second plurality of locations for the design layout having the at least tens of thousands of sets of template cells in the second design file (at operation 745).

In some examples, the computing system generates a first cell. In some cases, the first cell includes a first pattern corresponding to a first pattern of each set of one group of interposer microbump contact pads, a second pattern corresponding to a second pattern of each set of a corresponding group of interposer chip connection contact pads, and a third pattern of a corresponding set of interconnections through the one or more layers of the interposer device. In some instances, a center of the first pattern, a center of the second pattern, and a center of the third pattern are aligned vertically with each other. In examples, the first pattern of each set of the one group of interposer microbump contact pads includes one of:
(a) two interposer microbump contact pads arranged on opposite sides of a center of the first pattern (as depicted, e.g., by the pattern of interposer microbump contact pads 225b in FIG. 2C);
(b) four interposer microbump contact pads arranged in a cross pattern centered relative to the center of the first pattern (as depicted, e.g., by the pattern of interposer microbump contact pads 225a in FIG. 2G);
(c) four interposer microbump contact pads arranged at corners of a box pattern centered relative to the center of the first pattern (as depicted, e.g., by the pattern of interposer microbump contact pads 225a in FIG. 2I);
(d) four interposer microbump contact pads arranged in a step pattern centered relative to the center of the first pattern (as depicted, e.g., by the pattern of interposer microbump contact pads 225b in FIG. 2I);
(e) five interposer microbump contact pads arranged with four interposer microbump contact pads at corners of the box pattern with a fifth interposer microbump contact pad at an edge of the box pattern between two interposer microbump contact pads at adjacent corners of the box pattern of the first pattern;
(f) six interposer microbump contact pads arranged in two parallel lines on opposite sides of the center of the first pattern (as depicted, e.g., by the pattern of interposer microbump contact pads 225b in FIG. 2G); or
(g) eight interposer microbump contact pads with four interposer microbump contact pads arranged at both the corners of the box pattern and each of four other interposer microbump contact pads on each edge of the box pattern between adjacent corners of the box pattern of the first pattern (as depicted, e.g., by the pattern of interposer microbump contact pads 225a in FIG. 2C).

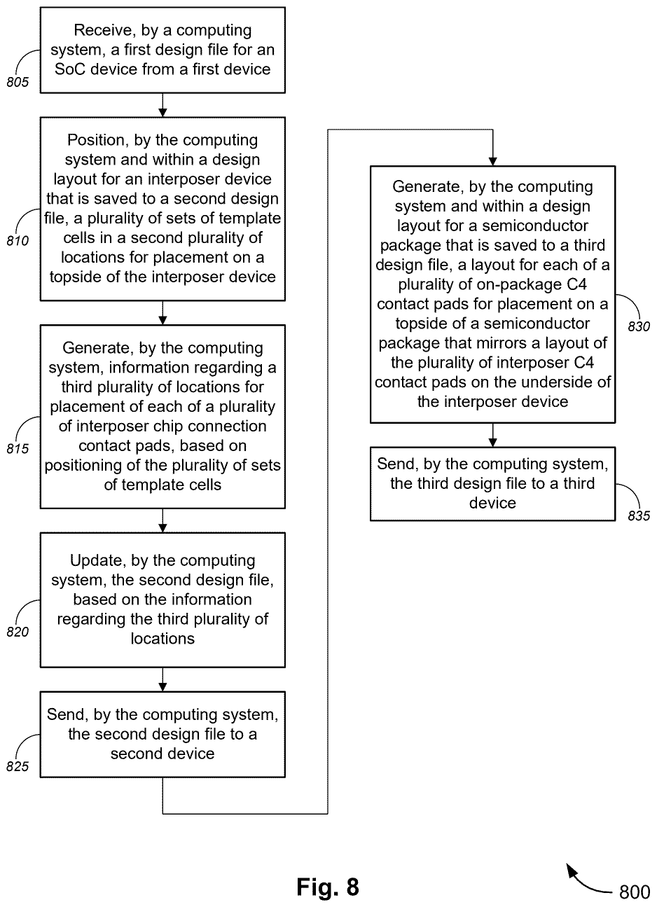

FIG. 8 depicts another example method 800 for implementing template cell alignment for interposer layout design. Referring to FIG. 8, the operations of example method 800 may be performed by a computing system (e.g., computing system 115 of FIG. 1).

In the example method 800 of FIG. 8, at operation 805, a computing system receives a first design file for an SoC device from a first device. In examples, the first design file includes first data indicating a first plurality of locations for placement of each of a plurality of sets of SoC microbump contact pads on an underside of a die corresponding to the SoC device. At operation 810, the computing system positions, within a design layout for an interposer device that is saved to a second design file, a plurality of sets of template cells in a second plurality of locations for placement on a topside of the interposer device. In examples, the second plurality of locations aligns with the first plurality of locations when the SoC device is mounted on the interposer device. In some cases, each template cell of the plurality of sets of template cells includes a pattern of interposer microbump contact pads that mirrors a pattern of SoC microbump contact pads of a corresponding set of SoC microbump contact pads in terms of (i) a combination of number and arrangement of interposer microbump contact pads, (ii) a pattern of interposer chip connection contact pads, and (iii) a pattern of a set of interconnections through one or more layers of the interposer device between the interposer microbump contact pads and the interposer chip connection contact pads for that template cell. In some instances, a center of the pattern of interposer microbump contact pads, a center of the pattern of the interposer chip connection contact pads, and a center of the pattern of the set of interconnections for that template cell are aligned vertically with each other.

At operation 815, the computing system generates information regarding a third plurality of locations for placement of each of a plurality of interposer chip connection contact pads, based on positioning of the plurality of sets of template cells. At operation 820, the computing system updates the second design file, based on the information regarding the third plurality of locations. At operation 825, the computing system sends the second design file to a second device.

In some examples, the plurality of interposer chip connection contact pads includes a plurality of C4 contact pads, and method 800, at operation 830, further includes the computing system generating, within a design layout for a semiconductor package that is saved to a third design file, a layout for each of a plurality of on-package C4 contact pads for placement on a topside of a semiconductor package that mirrors a layout of the plurality of interposer C4 contact pads on the underside of the interposer device. At operation 835, the computing system sends the third design file to a third device. In some instances, the third device associated with manufacturing equipment for producing the semiconductor package with the plurality of on-package C4 contact pads is positioned on the topside of the semiconductor package, based on the layout.

In examples, the first data further includes a listing of each set of SoC microbump contact pads for each group of SoC microbump contact pads together with corresponding locations among the first plurality of locations. In some cases, the first data is directed to a layout having at least tens of thousands of sets of SoC microbump contact pads among the plurality of sets of SoC microbump contact pads, while the second data is directed to a design layout having a corresponding at least tens of thousands of sets of template cells. In some instances, the first data further includes an indication of a connection label corresponding to a designed purpose and functionality for each interposer chip connection contact pad listed together with a corresponding one of the plurality of sets of SoC microbump contact pads and the corresponding locations among the first plurality of locations.

In some examples, the computing system generates a first cell. In some cases, the first cell includes a first pattern corresponding to a first pattern of each set of one group of interposer microbump contact pads, a second pattern corresponding to a second pattern of each set of a corresponding group of interposer chip connection contact pads, and a third pattern of a corresponding set of interconnections through the one or more layers of the interposer device. In some instances, a center of the first pattern, a center of the second pattern, and a center of the third pattern are aligned vertically with each other. In examples, the first pattern of each set of the one group of interposer microbump contact pads includes one of the patterns in the list (a)-(f) as described above with respect to FIG. 7.

While the techniques and procedures in methods 400, 500, 600, 700, and 800 are depicted and/or described in a certain order for purposes of illustration, it should be appreciated that certain procedures may be reordered and/or omitted within the scope of various embodiments. Moreover, while the methods 400, 500, 600, 700, and 800 may be implemented by or with (and, in some cases, are described below with respect to) the systems, examples, or embodiments 100, 200, 200A, 200B, 200C, and 300 of FIGS. 1, 2A, 2B-2E, 2F-2G, 2H-2I, and 3A-3D, respectively (or components thereof), such methods may also be implemented using any suitable hardware (or software) implementation. Similarly, while each of the systems, examples, or embodiments 100, 200, 200A, 200B, 200C, and 300 of FIGS. 1, 2A, 2B-2E, 2F-2G, 2H-2I, and 3A-3D, respectively (or components thereof), can operate according to the methods 400, 500, 600, 700, and 800 (e.g., by executing instructions embodied on a computer readable medium), the systems, examples, or embodiments 100, 200, 200A, 200B, 200C, and 300 of FIGS. 1, 2A, 2B-2E, 2F-2G, 2H-2I, and 3A-3D can each also operate according to other modes of operation and/or perform other suitable procedures.

As should be appreciated from the foregoing, the present technology provides multiple technical benefits and solutions to technical problems. For instance, designing IC devices generally raises multiple technical problems. For example, one technical problem arises from different design teams for components of the IC device (e.g., an SoC device design team, an interposer design team, a semiconductor package design team, and a place and route team) typically designing placement of contact points (e.g., contact pads) and interconnections based on internal team design requirements, leading to complicated interconnections and differing connection patterns, as discussed above.

The present technology provides for template cell alignment for interposer layout design. The present technology utilizes object template cells within a layout design UI (e.g., for the interposer). In some examples, the template cells include vertically aligned pattern templates of cells corresponding to a set of microbump contact pads of an SoC device, a set of microbump contact pads of an interposer, interconnections within the interposer, a chip connect contact pad of the interposer, and a chip connect contact pad of a semiconductor package. In examples, the vertically aligned pattern templates of cells are grouped to form a template cell of its own that can be duplicated for design of an IC device or for designs of multiple different IC devices across one or more IC design projects. In this manner, routing complexity is minimized, as is scenic routing (e.g., complicated, meandering routing) within layers of the interposer. Further, consistency, efficiency, reliability, and overall reduced complexity are achieved.

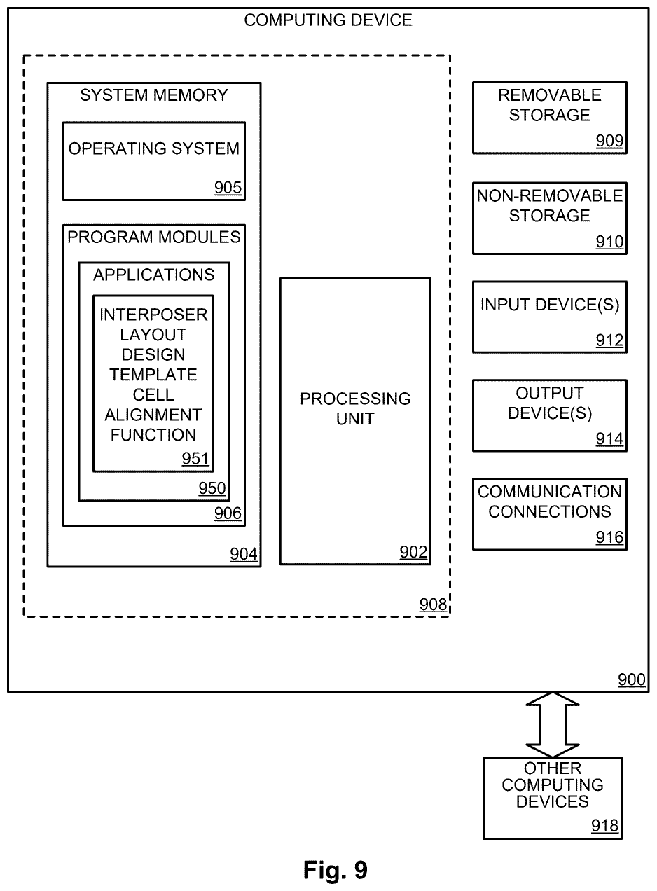

FIG. 9 depicts a block diagram illustrating physical components (i.e., hardware) of a computing device 900 with which examples of the present disclosure may be practiced. The computing device components described below may be suitable for a client device implementing the template cell alignment for interposer layout design, as discussed above. In a basic configuration, the computing device 900 may include at least one processing unit 902 and a system memory 904. The processing unit(s) (e.g., processors) may be referred to as a processing system. Depending on the configuration and type of computing device, the system memory 904 may include volatile storage (e.g., random access memory), non-volatile storage (e.g., read-only memory), flash memory, or any combination of such memories. The system memory 904 may include an operating system 905 and one or more program modules 906 suitable for running software applications 950, such as interposer layout design template cell alignment function 951, to implement one or more of the systems or methods described above.

The operating system 905, for example, may be suitable for controlling the operation of the computing device 900. Furthermore, aspects of the invention may be practiced in conjunction with a graphics library, other operating systems, or any other application program and is not limited to any particular application or system. This basic configuration is illustrated in FIG. 9 by those components within a dashed line 908. The computing device 900 may have additional features or functionalities. For example, the computing device 900 may also include additional data storage devices (which may be removable and/or non-removable), such as, for example, magnetic disks, optical disks, or tape. Such additional storage is illustrated in FIG. 9 by a removable storage device(s) 909 and a non-removable storage device(s) 910.

As stated above, a number of program modules and data files may be stored in the system memory 904. While executing on the processing unit 902, the program modules 906 may perform processes including one or more of the operations of the method(s) as illustrated in FIGS. 4A-8, or one or more operations of the system(s) and/or apparatus(es) as described with respect to FIGS. 1 and 2A-2E, or the like. Other program modules that may be used in accordance with examples of the present disclosure may include applications such as electronic mail and contacts applications, word processing applications, spreadsheet applications, database applications, slide presentation applications, drawing or computer-aided application programs, AI applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via an SoC where each or many of the components illustrated in FIG. 9 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 900 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 900 may also have one or more input devices 912 such as a keyboard, a mouse, a pen, a sound input device, and/or a touch input device, etc. The output device(s) 914 such as a display, speakers, and/or a printer, etc. may also be included. The aforementioned devices are examples and others may be used. The computing device 900 may include one or more communication connections 916 allowing communications with other computing devices 918. Examples of suitable communication connections 916 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 904, the removable storage device 909, and the non-removable storage device 910 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system that executes computer executable instructions that cause the system to perform operations comprising:
receiving a first design file for a system on a chip (“SoC”) device from a first device, the first design file including first data indicating a first plurality of locations of a plurality of groups of SoC microbump contact pads, each group of SoC microbump contact pads having a plurality of sets of SoC microbump contact pads with each set in that group having an identical pattern of SoC microbump contact pads as that of other sets in that group, each set of SoC microbump contact pads having a central point and two or more SoC microbump contact pads arranged in a pattern centered relative to that central point, the pattern of SoC microbump contact pads for each group of SoC microbump contact pads having a different combination of number and arrangement of SoC microbump contact pads compared with other groups of SoC microbump contact pads, the first plurality of locations corresponding to placement of the plurality of sets of SoC microbump contact pads for each group of SoC microbump contact pads on an underside of a die corresponding to the SoC device;
for each group of SoC microbump contact pads,
selecting a template cell, among a plurality of sets of template cells, for a group of interposer microbump contact pads to be disposed on a topside of an interposer device, based on the first data, the template cell including a pattern of interposer microbump contact pads that mirrors the pattern of SoC microbump contact pads for that group of SoC microbump contact pads in terms of a combination of number and arrangement of interposer microbump contact pads compared with that group of SoC microbump contact pads, each template cell further including a pattern of interposer chip connection contact pads and a pattern of a set of interconnections through one or more layers of the interposer device between the interposer microbump contact pads and the interposer chip connection contact pads for that template cell, wherein a center of the pattern of interposer microbump contact pads, a center of the pattern of the interposer chip connection contact pads, and a center of the pattern of the set of interconnections for that template cell are aligned vertically with each other; and
for each set of SoC microbump contact pads for that group of SoC microbump contact pads, autonomously positioning, within a second design file for the interposer device, the selected template cell for a corresponding group of interposer microbump contact pads at one of a second plurality of locations resulting in the interposer microbump contact pads for that group of interposer microbump contact pads being vertically aligned with the SoC microbump contact pads for that set of SoC microbump contact pads when the SoC device is mounted on the interposer device, where placement of the selected template cell corresponds to placement of the interposer chip connection contact pads for that template cell, among a plurality of interposer chip connection contact pads, on an underside of the interposer device; and
sending the second design file to a second device, the second design file including second data that is formatted based on manufacturing equipment settings and configurations, prior to manufacturing of the interposer device.

2. The system of claim 1, wherein the operations further comprise:
generating third data including a layout for a plurality of on-package chip connection contact pads for placement on a topside of a semiconductor package that mirrors a layout of the plurality of interposer chip connection contact pads on the underside of the interposer device; and
sending the third data to a third device, the third device associated with manufacturing equipment that is used to produce the semiconductor package with the plurality of on-package chip connection contact pads being positioned on the topside of the semiconductor package, based on the layout.

3. The system of claim 2, wherein the first device is an SoC design system, wherein the second device is a semiconductor package design system, wherein the plurality of interposer chip connection contact pads and the plurality of on-package chip connection contact pads are each a corresponding plurality of controlled collapse chip connection (“C4”) contact pads.

4. The system of claim 1, wherein the operations further comprise:
generating a first cell, the first cell including a first pattern corresponding to a first pattern of each set of one group of interposer microbump contact pads, a second pattern corresponding to a second pattern of each set of a corresponding group of interposer chip connection contact pads, and a third pattern of a corresponding set of interconnections through the one or more layers of the interposer device, wherein a center of the first pattern, a center of the second pattern, and a center of the third pattern are aligned vertically with each other.

5. The system of claim 4, wherein the first pattern of each set of the one group of interposer microbump contact pads includes one of two interposer microbump contact pads arranged on opposite sides of a center of the first pattern, four interposer microbump contact pads arranged in a cross pattern centered relative to the center of the first pattern, four interposer microbump contact pads arranged at corners of a box pattern centered relative to the center of the first pattern, four interposer microbump contact pads arranged in a step pattern centered relative to the center of the first pattern, five interposer microbump contact pads arranged with four interposer microbump contact pads at corners of the box pattern with a fifth interposer microbump contact pad at an edge of the box pattern between two interposer microbump contact pads at adjacent corners of the box pattern of the first pattern, six interposer microbump contact pads arranged in two parallel lines on opposite sides of the center of the first pattern, or eight interposer microbump contact pads with four interposer microbump contact pads arranged at both the corners of the box pattern and each of four other interposer microbump contact pads on each edge of the box pattern between adjacent corners of the box pattern of the first pattern.

6. The system of claim 1, wherein the first data further includes a listing of each set of SoC microbump contact pads for each group of SoC microbump contact pads together with corresponding locations among the first plurality of locations, wherein the first data is directed to a layout having at least tens of thousands of sets of SoC microbump contact pads among the plurality of groups of SoC microbump contact pads, wherein the second data is directed to a design layout having a corresponding at least tens of thousands of sets of template cells.

7. The system of claim 6, wherein the first data further includes an indication of a connection label corresponding to a designed purpose and functionality for each interposer chip connection contact pad listed together with a corresponding one of the plurality of sets of SoC microbump contact pads and the corresponding locations among the first plurality of locations.

8. The system of claim 7, wherein autonomously positioning, within the second design file for the interposer device, the selected template cell for each set of SoC microbump contact pads for that group of SoC microbump contact pads comprises, for that set of SoC microbump contact pads:
calculating a first set of two-dimensional (“2D”) coordinates for the selected template cell for a corresponding set of interposer microbump contact pads relative to a reference point within the design layout for the interposer device; and
adding the first set of 2D coordinates for the selected template cell to a listing of the second plurality of locations for the design layout having the at least tens of thousands of sets of template cells in the second design file.

9. A computer-implemented method, comprising:
receiving, by a computing system, a first design file for a system on a chip (“SoC”) device from a first device, the first design file including first data indicating a first plurality of locations for placement of each of a plurality of sets of SoC microbump contact pads on an underside of a die corresponding to the SoC device;
positioning, by the computing system and within a design layout for an interposer device that is saved to a second design file, a plurality of sets of template cells in a second plurality of locations for placement on a topside of the interposer device, wherein the second plurality of locations aligns with the first plurality of locations when the SoC device is mounted on the interposer device, each template cell of the plurality of sets of template cells including a pattern of interposer microbump contact pads that mirrors a pattern of SoC microbump contact pads of a corresponding set of SoC microbump contact pads in terms of a combination of number and arrangement of interposer microbump contact pads, a pattern of interposer chip connection contact pads, and a pattern of a set of interconnections through one or more layers of the interposer device between the interposer microbump contact pads and the interposer chip connection contact pads for that template cell, wherein a center of the pattern of interposer microbump contact pads, a center of the pattern of the interposer chip connection contact pads, and a center of the pattern of the set of interconnections for that template cell are aligned vertically with each other;
generating, by the computing system, information regarding a third plurality of locations for placement of each of a plurality of interposer chip connection contact pads, based on positioning of the plurality of sets of template cells;
updating, by the computing system, the second design file, based on the information regarding the third plurality of locations; and
sending, by the computing system, a second design file to a second device.

10. The computer-implemented method of claim 9, wherein the plurality of interposer chip connection contact pads includes a plurality of interposer controlled collapse chip connection (“C4”) contact pads, wherein the computer-implemented method further comprises:
generating, by the computing system and within a design layout for a semiconductor package that is saved to a third design file, a layout for each of a plurality of on-package C4 contact pads for placement on a topside of a semiconductor package that mirrors a layout of the plurality of interposer C4 contact pads on the underside of the interposer device; and
sending, by the computing system, the third design file to a third device, the third device associated with manufacturing equipment for producing the semiconductor package with the plurality of on-package C4 contact pads being positioned on the topside of the semiconductor package, based on the layout.

11. The computer-implemented method of claim 9, further comprising:
generating, by the computing system, a first cell, the first cell including a first pattern corresponding to a first pattern of each set of one group of interposer microbump contact pads, a second pattern corresponding to a second pattern of each set of a corresponding group of interposer chip connection contact pads, and a third pattern of a corresponding set of interconnections through the one or more layers of the interposer device, wherein a center of the first pattern, a center of the second pattern, and a center of the third pattern are aligned vertically with each other.

12. The computer-implemented method of claim 11, wherein the first pattern of each set of the one group of interposer microbump contact pads includes one of two interposer microbump contact pads arranged on opposite sides of a center of the first pattern, four interposer microbump contact pads arranged in a cross pattern centered relative to the center of the first pattern, four interposer microbump contact pads arranged at corners of a box pattern centered relative to the center of the first pattern, four interposer microbump contact pads arranged in a step pattern centered relative to the center of the first pattern, five interposer microbump contact pads arranged with four interposer microbump contact pads at corners of the box pattern with a fifth interposer microbump contact pad at an edge of the box pattern between two interposer microbump contact pads at adjacent corners of the box pattern of the first pattern, six interposer microbump contact pads arranged in two parallel lines on opposite sides of the center of the first pattern, or eight interposer microbump contact pads with four interposer microbump contact pads arranged at both the corners of the box pattern and each of four other interposer microbump contact pads on each edge of the box pattern between adjacent corners of the box pattern of the first pattern.

13. The computer-implemented method of claim 9, wherein the first data further includes a listing of each set of SoC microbump contact pads for each group of SoC microbump contact pads together with corresponding locations among the first plurality of locations, wherein the first data is directed to a layout having at least tens of thousands of sets of SoC microbump contact pads among the plurality of sets of SoC microbump contact pads, wherein the second data is directed to a design layout having a corresponding at least tens of thousands of sets of template cells.

14. The computer-implemented method of claim 13, wherein the first data further includes an indication of a connection label corresponding to a designed purpose and functionality for each interposer chip connection contact pad listed together with a corresponding one of the plurality of sets of SoC microbump contact pads and the corresponding locations among the first plurality of locations.

15. An integrated circuit (“IC”) device, comprising:
a first die corresponding to a first system on a chip (“SoC”) device, the first die including a first set of microbump contact pads disposed on an underside of the first die, the first set of microbump contact pads being arranged in a first pattern;
a semiconductor package including a first controlled collapse chip connection (“C4”) contact pad disposed on a topside of the semiconductor package; and
an interposer device including a second set of microbump contact pads disposed on a topside of the interposer device, a second C4 contact pad disposed on an underside of the interposer device, and a first set of interconnections through one or more layers of the interposer device between the second set of microbump contact pads and the second C4 contact pad, the second set of microbump contact pads being arranged in a second pattern that mirrors the first pattern;
wherein, when assembled with the interposer device being sandwiched between the first die and the semiconductor package and with solder material joining the first set of microbump contact pads to the second set of microbump contact pads and solder material joining the first C4 contact pad to the second C4 contact pad, a center of the first pattern of the first set of microbump contact pads, a center of the second pattern of the second set of microbump contact pads, a center of the first C4 contact pad, and a center of the second C4 contact pad are aligned vertically to within a tolerance value.

16. The IC device of claim 15,
wherein the first die further includes a plurality of third sets of microbump contact pads disposed on the underside of the first die, each third set of microbump contact pads being arranged in the first pattern;
wherein the semiconductor package further includes a plurality of third C4 contact pads on the topside of the semiconductor package;
wherein the interposer device further includes a plurality of fourth sets of microbump contact pads disposed on the topside of the interposer device, a plurality of fourth C4 contact pads disposed on the underside of the interposer device, and a plurality of second sets of interconnections through the one or more layers of the interposer device between each fourth set of microbump contact pads and one of the plurality of fourth C4 contact pads, each fourth set of microbump contact pads being arranged in the second pattern that mirrors the first pattern; and
wherein, when assembled with the interposer device being sandwiched between the first die and the semiconductor package and with solder material joining each third set of microbump contact pads to a corresponding one of the plurality of fourth sets of microbump contact pads and solder material joining each third C4 contact pads to a corresponding one of the fourth C4 contact pads, a center of the first pattern of each third set of microbump contact pads, a center of the second pattern of a corresponding one of the plurality of fourth sets of microbump contact pads, a center of one of the plurality of third C4 contact pads, and a center of a corresponding one of the plurality of fourth C4 contact pads are aligned vertically to within the tolerance value.

17. The IC device of claim 16, further comprising:
a second die corresponding to a second SoC device, the second die including a plurality of fifth sets of microbump contact pads disposed on an underside of the second die, each fifth set of microbump contact pads being arranged in the first pattern;
wherein the semiconductor package further includes a plurality of fifth C4 contact pads on the topside of the semiconductor package;
wherein the interposer device further includes a plurality of sixth sets of microbump contact pads disposed on the topside of the interposer device, a plurality of sixth C4 contact pads disposed on the underside of the interposer device, and a plurality of third sets of interconnections through the one or more layers of the interposer device between each sixth set of microbump contact pads and one of the plurality of sixth C4 contact pads, each sixth set of microbump contact pads being arranged in the second pattern that mirrors the first pattern; and
wherein, when assembled with the interposer device being sandwiched between the second die and the semiconductor package and with solder material joining each fifth set of microbump contact pads to a corresponding one of the plurality of sixth sets of microbump contact pads and solder material joining each fifth C4 contact pads to a corresponding one of the sixth C4 contact pads, a center of the first pattern of each fifth set of microbump contact pads, a center of the second pattern of a corresponding one of the plurality of sixth sets of microbump contact pads, a center of one of the plurality of fifth C4 contact pads, and a center of a corresponding one of the plurality of sixth C4 contact pads are aligned vertically to within the tolerance value.

18. The IC device of claim 15, wherein the first pattern includes one or more first pairs of microbump contact pads, each first pair of microbump contact pads being arranged symmetrically with respect to the center of the first pattern, wherein the second pattern includes a corresponding one or more second pairs of microbump contact pads that mirror the one or more first pairs of microbump contact pads of the first pattern.

19. The IC device of claim 15, wherein the first set of interconnections of the interposer device further includes a vertical single pin connection that connects with the second C4 contact pad on an underside end of the vertical single pin connection and each of the microbump contact pads of the second set of microbump contact pads via corresponding connections on a topside end of the vertical single pin connection.

20. The IC device of claim 15, wherein the first set of interconnections of the interposer device further includes a vertical multi-pin connection that connects with the second C4 contact pad on an underside end of the vertical multi-pin connection and each of the microbump contact pads of the second set of microbump contact pads via corresponding connections on a topside end of the vertical multi-pin connection.
